(19) United States
(12) Patent Application Publication
(10) Pub. No.: US 2012/0321362 A1
(43) Pub. Date: Dec. 20, 2012

(54) HEATING APPARATUS

(75) Inventor: Kenichi Hirota, Joso-shi (JP)

(73) Assignee: CANON KABUSHIKI KAISHA, Tokyo (JP)

(21) Appl. No.: 13/524,498

(22) Filed: Jun. 15, 2012

(30) Foreign Application Priority Data
Jun. 20, 2011 (JP) 2011-136284

(51) Int. Cl. G03G 15/20

(52) U.S. Cl. 399/341

(57) ABSTRACT

A heating apparatus includes a film; a film conveying device; a heating device, contactable to a film surface opposite from another film surface where the film is contactable to the recording material, for selectively heating the recording material via the film in a heating region with respect to a direction perpendicular to a conveyance direction of the recording material; a recording material conveying device for conveying the recording material toward a film contact portion; and a control device for controlling, when a plurality of recording materials are heated by the heating device, the recording material conveying device to convey the recording materials toward the film contact portion so that a heating region of the recording material is contacted to the film and so that at least a part of a region of the recording material other than the heating region overlaps another recording material.

### FIELD OF THE INVENTION AND RELATED ART

The present invention relates to a heating apparatus for partly heating a surface of a medium to be treated (recording material) via a film.

Most of conventional prints have surface glossiness values varying depending on a print ratio due to a difference in glossiness between a recording material and a colorant. Various methods for creating a uniform glossy surface over the entire surface of the print by subjecting the print to various post-treatment steps such that the print is overcoated have been proposed.

Further, in recent years, various glossiness control techniques have also been proposed. For example, in offset printing, various glossiness representations are enabled by the following method. That is, after the recording material is subjected to printing with coloring ink, the recording material is subjected to the offset printing with UV=curable transparent (clear) ink at a specific portion. Then, the entire surface of the resultant print is irradiated with UV light to fix thereon the UV-curable transparent ink. According to this method, glossiness at the specific portion (photograph or headline portion) can be improved, so that it is possible to output the print rich in visual effect.

In an electrophotographic type, a method in which the entire surface of the print is improved in glossiness to effect photograph-like recording is proposed (Japanese Laid-Open Patent Application (JP-A) 2007-086747). In this method, the surface of the print on which an image is formed with a toner is re-heated via an endless belt having a high surface smoothness, so that the toner is re-melted. Thereafter, the toner is cooled in a state in which the toner is contacted to the belt, so that the toner is solidified in a state in which the smoothness of the belt is transferred onto the surface of the image formed with the toner. According to this method, the glossiness of the entire print can be controlled but it is difficult to partly control the glossiness of the print surface.

The above-described method in which the recording material is subjected to the offset printing with the UV-curable transparent ink is capable of partly imparting glossiness (gloss property) to the print. However, in the case where the offset printing is effected, a print cost is increased unless the prints are made in a certain volume. For that reason, the above-described method is not suitable for printing in a small number of prints and variable printing in which a print job is different every sheet.

Further, in the above-described method of imparting glossiness to the image formed in the electrophotographic type, the endless belt having a relatively large thickness is used as the belt and a heating roller is used as a heating source. This endless belt can be used repetitively and on the other hand, the endless belt is formed in relatively large thickness in many cases in order to sufficiently withstand repetitive use. For this reason, in order to sufficiently re-melt the toner, there is a need to sufficiently supply a heat quantity by using the heating roller or the like. Therefore, it would be considered that the above-described glossiness-imparting method is suitable for the case where the glossiness is imparted to the entire surface of the print but is not suitable for the case where the glossiness is intended to be partly imparted to the print.

In order to meet such a demand, the present inventor devised a method in which a thermal head and a thin film are used to impart glossiness to the medium to be treated at a desired position with a desired shape.

However, in this method, it becomes difficult to re-use the thin film since the thin film is deformed by selective heating. For that reason, the film is used once and then thrown away, so that a running cost is increased. Particularly, in the case where at a treatment portion where surface treatment of the medium to be treated is effected, treatment is made by bringing the film and the medium to be treated into contact with each other in a nip formed by the thermal head and a platen roller, the film is consumed simultaneously with start of conveyance of the medium to be treated. For that reason, in the case where a treatment region is small, the film having a large unused region is used once and then thrown away and therefore there arises a problem of an increase in running cost.

### SUMMARY OF THE INVENTION

A principal object of the present invention is to provide a heating apparatus, in which a medium to be treated is heated via a film and thus a surface property of a surface of the medium to be treated can be partly controlled, capable of reducing a running cost and improving productivity.

According to as aspect of the present invention, there is provided a heating apparatus comprising: a film contactable to a recording material; a film conveying device for conveying the film; a heating device, contactable to a surface of the film opposite from another surface of the film where the film is contactable to the recording material, for selectively heating the recording material via the film with respect to a direction substantially perpendicular to a conveyance direction of the recording material; a recording material conveying device for conveying the recording material toward a contact portion where the recording material is to be contacted to the film; and a control device for controlling, when a plurality of recording materials are heated by the heating device, the recording material conveying device to convey the recording materials toward the contact portion so that a heating region of the recording material to be selectively heated by the heating device is contacted to the film and so that at least a part of a region of the recording material other than the heating region overlaps another recording material.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic sectional view of a heating apparatus in Embodiment 1.

FIG. 2 is an illustration showing a state in which upward overlapping is made by an overlapping conveyance unit of the heating apparatus in Embodiment 1.

FIG. 3 is an illustration showing a state in which downward overlapping is made by the overlapping conveyance unit of the heating apparatus in Embodiment 1.

FIGS. 4, 5 and 6 are schematic views for illustrating a contact and separation operation of a thermal head.

FIG. 7 is a schematic sectional view showing an example of a structure of the thermal head.

FIG. 8 is a circuit diagram showing an example of a thermal head driving circuit.

FIG. 9 is a block diagram for illustrating a schematic control manner of the heating apparatus in Embodiment 1.

FIGS. 10 to 13 are schematic views each for illustrating an example of a relationship between treatment region information and an overlapping amount in an overlapping operation.

Parts (a) to (d) of FIG. 14 and (a) to (d) of FIG. 15 are schematic views each for illustrating a state of a medium to be treated in the overlapping conveyance unit at an associated stage in the overlapping operation.

FIG. 16 is a flow chart for illustrating an operation flow from the overlapping operation until surface treatment.

FIG. 17 is a schematic view for illustrating an overlapping conveyance unit including a moving means for moving the medium to be treated in a direction substantially perpendicular to a conveyance direction in a heating apparatus in another embodiment.

FIG. 18 is a schematic sectional view of an image forming system provided with a surface treatment apparatus in Embodiment 1.

### DESCRIPTION OF THE PREFERRED EMBODIMENTS

The heating apparatus (surface treatment apparatus) of the present invention will be described specifically with reference to the drawings.

### Embodiment 1

### 1. General Structure of Heating Apparatus (Surface Treatment Apparatus)

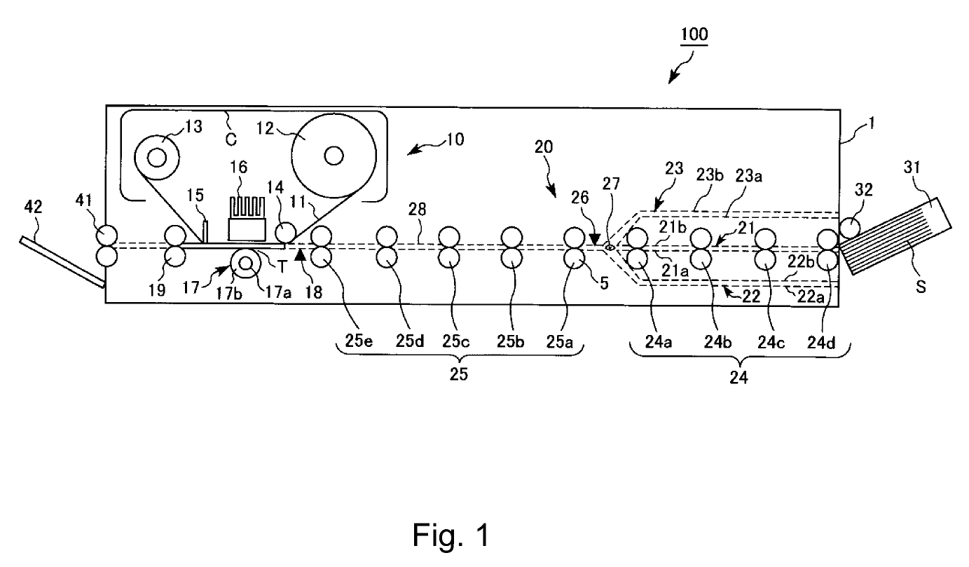

FIG. 1 is a schematic sectional view of a surface treatment apparatus 100 as a heating apparatus according to this embodiment of the present invention. In this embodiment, the surface treatment apparatus 100 effects treatment (surface treatment) for controlling a surface property of a recording material, as a medium to be treated S, on which an image is separately formed with a thermally meltable toner by an image forming apparatus of an electrophotographic type.

The surface treatment apparatus 100 includes an apparatus main assembly 1, a cassette 31 in which sheets of the medium to be treated S are stacked, and a feeding roller 32 for separating and feeding the medium to be treated S one by one from the cassette 31. Further, the surface treatment apparatus 100 includes a discharging roller pair 41 for discharging the medium to be treated S, after being subjected to the surface treatment, to the outside of a casing of the apparatus main assembly 1, and a discharge tray 42 on which the medium to be treated S discharged from the apparatus main assembly 1 is stacked. Further, the surface treatment apparatus 100 includes a treatment unit 10 as a treatment means for executing the surface treatment and an overlapping conveyance unit 20 as a medium to be treated-conveying means (medium to be treated-overlapping means) described later. The treatment unit 10 is constituted by a film 11, a feeding shaft 12, a winding shaft 13, a stretching roller 14, a separating member 15, a thermal head 16, a platen roller 17, a second sensor 18 for the medium to be treated S, a downstream conveying roller pair 19, and the like. Further, as will be described later specifically, the overlapping conveyance unit 20 is constituted by members including conveying roller pairs 24 (24a, 24b, 24c, 24d) and 25 (25a, 25b, 25c, 25d, 25e) for nip-conveying the medium to be treated S, first to third conveying paths 21, 22 and 23, a flapper 27 and a first sensor 26 for the medium to be treated S.

In the surface treatment apparatus 100, the platen roller 17 which is a roller-type platen as a supporting member and the thermal head 16 which is a contact-type local heating apparatus as a heating means are oppositely disposed via the conveying path for the medium to be treated S. The platen roller 17 constitutes a support for the thermal head 16 when the thermal head 16 is urged as described later via the film 11 and the medium to be treated S, and conveys the medium to be treated S. The thermal head 16 selectively generates heat the medium to be treated S depending on treatment region information described later.

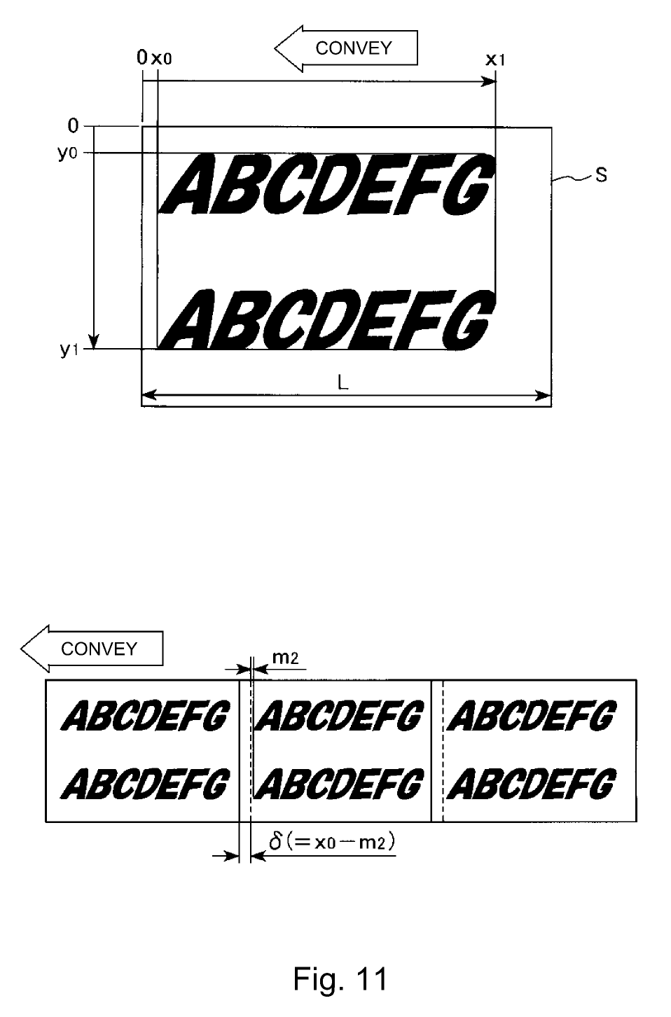

The surface treatment apparatus 100 includes the film 11 which is urged against the medium to be treated S by the thermal head 16 and is selectively heated by the thermal head 16, the winding shaft 13 as a winding means of the film 11, and the feeding shaft 12 as a feeding means of the film 11. The winding shaft 13 constitutes a film conveying means. The winding shaft 13 is rotationally driven by a winding shaft driving motor 13A (FIG. 9) as a driving source. The winding shaft driving motor 13A is capable of rotationally driving the winding shaft 13 in a direction in which the film 11 is wound up from the feeding shaft 12 to the winding shaft 13. At this time, the feeding shaft 12 is rotatable in a direction in which the film 11 is fed toward the winding shaft 13. Incidentally, an urging means for urging the feeding shaft 12 in a direction, in which the feeding shaft 12 is rotated in a direction opposite to the above direction, to prevent slack in the film 11 may also be provided.

Here, the surface of the film 11 contacting the medium to be treated S is a front surface, and the surface opposite from the front surface is a back surface. The surface of the medium to be treated S contacting the film 11 is a front surface, and the surface, contacting the platen roller 17, opposite from the front surface is a back surface. Further, the conveyance direction of the medium to be treated S is the direction in which the medium to be treated S is conveyed when the surface treatment is executed. Further, with respect to the conveying path of the medium to be treated S, upstream (side) and downstream (side) refer to those when the medium to be treated S is conveyed in the conveyance direction during the execution of the surface treatment.

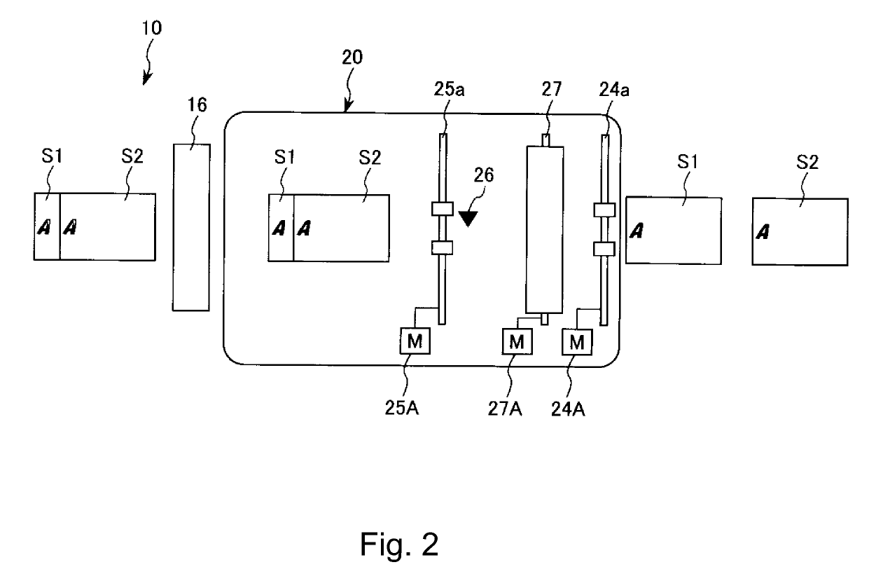

The surface treatment apparatus 100 further includes the stretching roller 14 provided in contact with the back surface of the film 11, and the separating member 15, provided in contact with the back surface of the film 11, for separating the medium to be treated S from the film 11 heated and urged by the thermal head 16. Rotational axis directions of the feeding shaft 12, the winding shaft 13, the platen roller 17 and the stretching roller 14 and a longitudinal direction of the separating member 15 are substantially parallel to each other. The film 11 is fed from the feeding shaft 12 is extended around a part of the outer periphery of the stretching roller 14 and is guided to a treatment portion T which is an urging portion (nip) between the thermal head 16 and the platen roller 17. Then, the film 11 is passed through the treatment portion T, bent by the separating member 15, guided to the winding shaft 13, and then is wound up by the winding shaft 13. The conveyance direction of this film 11 is referred to a forward direction. The conveyance direction of the film 11 is substantially perpendicular to the rotational axis directions of the feeding shaft 12, the winding shaft 13, the platen roller 17 and the stretching roller 14 and the longitudinal direction of the separating member 15. When the surface treatment of the medium to be treated S is effected, at the treatment portion T, the conveyance directions of the film 11 and the medium to be treated S are the same. The stretching roller 14 is a rotatable guide roller for stretching and guiding the film 11. The stretching roller 14 is rotated, by the conveyance of the film. In the upstream side of the treatment portion T with respect to the conveyance direction of the medium to be treated S, a group of forward/reverse conveying roller pairs 25 consisting of a plurality of conveying roller pairs 25a to 25e which are mutually urged as conveying means constituting the overlapping conveyance unit 20 described later specifically are provided. The group of forward/reverse conveying roller pairs 25 have, as described later specifically, the function of not only conveying the medium to be treated S in the forward direction and a backward direction when the sheets of the medium to be treated S are superposed (laid) and conveyed but also adjusting an attitude of the medium to be treated S before the treatment is made. The group of forward/reverse conveying roller pairs 25 are rotationally driven by a forward/reverse conveying roller pair group driving motor 25A (FIGS. 2, 3 and 9) as a driving source. The group of forward/reverse conveying roller pairs 25 make, as described later specifically, correction of oblique movement of the medium to be treated S and convey the medium to be treated S to the treatment portion T while performing forward/reverse rotation operation for conveying the sheets of the medium to be treated S in a superposition manner as desired. The oblique movement of the medium to be treated S is corrected by abutment of a leading end of the medium to be treated S with respect to the conveyance direction against the contact portion (nip) of the upstreammost conveying roller pair 25a of the group of forward/reverse conveying roller pair 25 of which rotation is stopped.

The surface treatment apparatus 100 further includes a group of upstream conveying roller pairs 24 consisting of a plurality of conveying roller pairs 24a to 24d which are mutually urged in the upstream side of the group of forward/reverse conveying roller pairs 25 with respect to the conveyance direction of the medium to be treated S. The group of upstream conveying roller pairs 24 convey the medium to be treated S fed by the feeding roller 32 into the first conveying path 21 and deliver the medium to be treated S to the group of forward/reverse conveying roller pairs 25. The surface treatment apparatus 100 in this embodiment further includes the second and third conveying paths 22 and 23 in addition to the first conveying path 21. As will be described specifically, the second and third conveying paths 22 and 23 are used for conveying superposedly the sheets of the medium to be treated S in combination with the group of forward/reverse conveying roller pairs 25, the first sensor 26 for the medium to be treated S, the flapper 27, and the like.

Further, the surface treatment apparatus 100 includes the downstream conveying roller pair 19, which is a mutually urged conveying roller pair, provided downstream of the treatment portion T with respect to the conveyance direction of the medium to be treated S. The downstream conveying roller pair 19 conveys the medium to be treated S after the treatment to the discharge tray 42 outside the surface treatment apparatus 100 or to a post-treatment step.

Further, the surface treatment apparatus 100 includes the second sensor 18, for the medium to be treated S, for detecting the presence/absence of the medium to be treated S is provided downstream of the group of forward/reverse conveying roller pairs 25 (downstream of the downstreammost conveying roller pair 25e) and upstream of the stretching roller 14 with respect to the conveyance direction of the medium to be treated S. By the second sensor 18 for the medium to be treated S, it is possible to detect the medium to be treated S during the conveyance. Incidentally, as will be described later specifically, the surface treatment apparatus 100 includes the first sensor 26, for the medium to be treated S, for detecting the presence/absence of the medium to be treated S is provided downstream of the flapper 27 and upstream of the group of forward/reverse conveying roller pairs 25 (upstream of the upstreammost conveying roller pair 25a) with respect to the conveyance direction of the medium to be treated S. For that reason, by using a detection result of this first sensor 26 for the medium to be treated S, operation timing of the treatment unit 10 can be controlled. In this case, the second sensor 18 for the medium to be treated S is not required to be provided.

In this embodiment, the film 11, the feeding shaft 12 and the winding shaft 13 are accommodated in a film cassette C, thus being integrally detachably mountable to the apparatus main assembly 1.

The surface treatment apparatus 100 further includes the discharging roller pair 41 for discharging the medium to be treated S after being subjected to the surface treatment to the outside of the casing of the apparatus main assembly 1. Further, the surface treatment apparatus 100 includes the discharge tray 42 on which the discharged sheets of the medium to be treated S are stacked outside the apparatus main assembly 1.

### 2. Constitutions of Parts of Treatment Unit

Next, constitutions of parts of the treatment unit will be described specifically.

### 2-1. Thermal Head

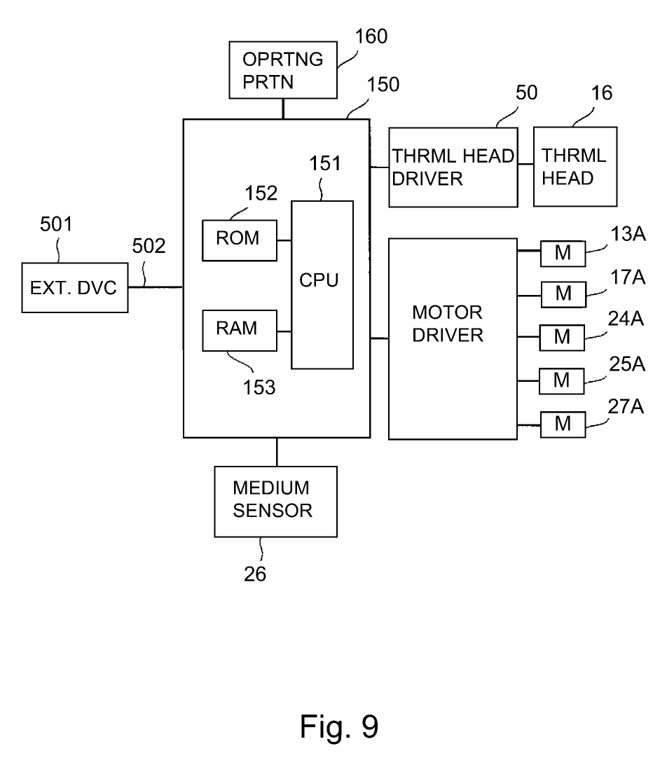

Basic constitution and basic specifications of the thermal head 16 will be described. FIG. 7 is a schematic illustration of a structure of a heat generating element of the thermal head 16. The thermal head 16 is constituted by forming a common electrode 53a and a lead (individual) electrode 53b on a glaze 52 (heat retaining layer) printed on a substrate 51 of alumina or the like and by forming a heat generating resistor 55 on the lower surfaces of these electrodes 53a and 53b. Further, on the upper surfaces of the substrate 51, the heat retaining layer 52, the electrodes 53a and 53b and the heat generating resistor 55, a protective layer 54 (overcoating layer) is formed. Further, to the thermal head 16, a driving circuit 50 (FIG. 9) for selectively applying electric power to the heat generating element to generate heat is connected. Further, the thermal head 16 is provided with a heat dissipation plate for dissipating excessive heat after the heat is applied to the medium to be treated S. The thermal head 16 includes a plurality of heat generating elements arranged in line along a direction substantially perpendicular to the conveyance direction of the medium to be treated S and selectively heats different regions with respect to an arrangement direction, thus being capable of heating the surface of the medium to be treated S via the film 11.

The thermal head 16 used in this embodiment is 300 dpi in heat generating element density, 300 dpi in recording density (treatment density), 30 V in driving voltage, and 5000Ω in average resistance of the heat generating elements. However, the constitution and specifications of the thermal head 16 are not limited to those in this embodiment.

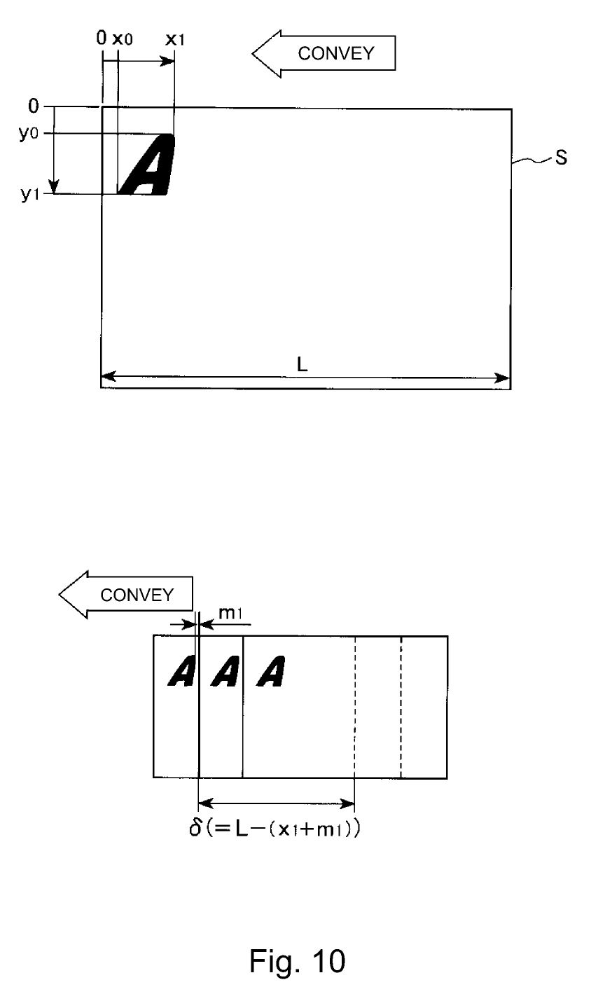

FIG. 8 is a schematic illustration of the driving circuit 50 of the thermal head 16 in general. On the alumina substrate, the heat generating resistors for one line are provided and in both sides thereof, the electrodes are wired. Further, a driver IC including a group of shift resistors for transferring and maintaining data (treatment region information) for one line is provided on the same alumina substrate or a wiring substrate separately provided.

### 2-2. Platen Roller

The platen roller 17 is an elastic roller prepared by forming in a roller shape an elastic layer 17b with a high friction coefficient member such as a hard rubber on a peripheral surface of a shaft (core metal) 17a. In this embodiment, a heat-resistant rubber roller prepared by forming the elastic layer 17b with silicone rubber in the roller shape around the shaft 17a. The platen roller 17 is rotatably mounted in the apparatus main assembly 1 by the shaft 17a. Further, via the shaft 17a, the platen roller 17 is rotationally driven by a platen roller driving motor 17A (FIG. 9) as a driving source, so that the medium to be treated S and the film 11 are conveyed. In this embodiment, a conveying speed of the medium to be treated S is determined by a rotational speed of the platen roller 17, and the data (treatment region information) sent to the thermal head 16 is formed on the basis of the rotational speed of the platen roller 17. In this embodiment, during the surface treatment, at the treatment portion T, the medium to be treated S and the film 11 are constituted in the same direction at the substantially same speed.

### 2-3. Film

The film (transfer film) 11 is wound up and held in a desired length by the feeding shaft 12 and is fed to the treatment portion T by being wound by the winding shaft 13 as desired. The film 11 may desirably constituted with a thin flexible material (member) in order to locally heat the surface of the medium to be treated S. From this viewpoint, the film 11 may preferably have a thickness of 40 μm or less. The film 11 can be made thin until 2 μm from the viewpoint of the surface treatment but may preferably have the thickness of 4 μm or more from the viewpoint of strength. Further, in the surface treatment, in order to obtain a surface property excellent in photograph-like image representation property, rigidity of the film 11 to some extent is effective, so that the film 11 formed of the following material may preferably have the thickness of 8 μm or more. Further, with respect to the material for the film 11, heat resistivity against the thermal head 16 is required. The material such as polyimide having a heat-resistant temperature exceeding 200° C. is desirable. However, although thermal history is left, it is possible to employ a general-purpose inexpensive resin film (thermoplastic film) such as PET (polyethylene terephthalate). Further, the surface layer (contacting the medium to be treated S) of the film 11 can be subjected to parting coating. The resultant functional layer is a coating layer with low surface energy and can be provided in order to improve a parting property between the film 11 and the surface resin layer of the medium to be treated S. For transferring the surface shape of the film 11 onto the surface of the medium to be treated S, the film 11 may desirably be smoothly parted from the viewpoint of accurate transfer. As a composition of the material for the purpose, fluorine-containing resin, silicone resin and the like can be used. Further, with respect to a film forming method, coating can be used but the method is not limited to the coating but it is important that the surface property to be transferred can be finally provided. For example, in order to create a smooth surface for photograph, the smooth surface can be created by subjecting a base film to the coating. Further, on the back surface (slidable on the thermal head 16) of the film 11, a sticking preventing layer can be provided in order to reduce a degree of mechanical friction with the thermal head 16. A characteristic close to the above-described parting coating is required and therefore specifically, the coating with the fluorine-containing resin, the silicone resin or the like similarly as in the case of the parting layer. In this embodiment, as the film 11, a film prepared by subjecting the PET film (base material) to the parting coating and by forming the sticking preventing layer on the PET film was used.

The film 11 transfers its surface property (surface shape) onto the medium to be treated S and therefore is, when it is a highly glossy smooth film, capable of treating the surface of the medium to be treated S to a photograph-like glossy surface with high glossiness. Further, on the other hand, when a mat film subjected to sand blasting or a film provided with a specific shape is used, it is possible to transfer a reversed shape of its shape onto the medium to be treated S. For example, shapes with various textures of mat paper, Japanese paper and embossed paper can be transferred. Further, a geometric pattern can also be provided, so that various textures such as a lattice pattern can be transferred. Further, by forming a geometric structure of the order from 1 μm to sub-μm, it is possible to transfer the surface which exhibits hologram color. That is, in the surface treatment, it is possible to not only impart the high glossiness but also lower the glossiness property to a desired glossiness. For example, as the film 11, when a film having a texture surface such as a satin-finished surface is used, the texture surface can be transferred onto the surface of the medium to be treated S, so that the glossiness property can also be decreased.

In this embodiment, the film 11 is supplied as the cassette C and can be exchangeable. Further, in this embodiment, the surface treatment apparatus 100 can effect partial treatment and therefore a plurality of films 11 different in types selected from the above-described films are provided, so that it is possible to effect the treatment for providing the various shapes or the hologram color at desired positions.

In this embodiment, the film 11 has a size of 320 mm to 350 mm in width with respect to the direction substantially perpendicular to its conveyance direction, and the thermal head 16 has also the same size (width) with respect to the same direction. As a result, the film 11 can meet the sheets of the medium to be treated S having various sizes up to about A3 size. Further, in this embodiment, the film 11 has the smooth surface and is used for imparting the glossiness to the medium to be treated S. Further, in this embodiment, the film 11 is the thermoplastic film and due to its thinness, when the film 11 is once used, creases are generated at the heating portion and therefore cannot be used again.

### 2-4. Separating Portion

A portion (separating portion) where the medium to be treated S is separated from the film 11 will be described. From proper surface treatment, constitutions of the thermal head 16 and a separating portion are important. In this embodiment, the separating member 15 performs two functions, i.e., a cooling function for the film 11 and a separating function of separating the medium to be treated S from the film 11 by curvature. In this embodiment, the separating member 15 is constituted by a metal member such as SUS plate and a separation curvature is set at a sufficiently small value (1 min. in terms of radius of curvature). As a result, the medium to be treated S was capable of being separated from the film 11 with reliability.

Further, the separating member 15 may desirably be provided with a cooling mechanism (not shown) for suppressing temperature rise at the separating portion. As the cooling mechanism, provision of an air-cooling mechanism, a cooling fin or the like is effective.

Further, the temperature at the separating portion is monitored by a thermistor resistor as a temperature detecting means provided at a plurality of positions. An air flow rate of the fan or a printing operation is controlled so that the temperature at the separating portion is a target cooling temperature T1 (° C.) or less. The target cooling temperature may desirably be equal to a glass transition temperature (Tg) of the surface layer resin (thermoplastic resin) of the medium to be treated S as the colorant or the overcoating material. When a deviation between Tg and a melting start temperature is taken into consideration, the target cooling temperature may preferably be set at a value of about (Tg+15° C.) or less, more preferably Tg or less. Further, the colorant layer may contain a component such as wax other than the resin and the colorant. In this case, the target cooling temperature may preferably be set at a value which is not more than a melting point of the wax. In the case where the recording material (material to be heated) is not specified, the target cooling temperature may preferably be set at a sufficiently low temperature such as about room temperature. For example, the target cooling temperature may preferably be about 30° C. to 50° C.

### 2-5. Medium to be Treated (Cut Paper)

In this embodiment, as the medium to be treated S, a printed product (recording material) outputted by the electrophotographic image forming apparatus. For example, a recording material on which an image is formed by a four-color (CMYK) process and a recording material on which an image is formed by a five-color process in which a recording image with toners the four colors of CMYK and a transparent image with a transparent toner which does not contain the colorant and which is formed principally of a resin are used may be cited. At the transparent toner, it is possible to use a toner which does not contain a pigment and which is constituted principally by polyester resin. Further, as the transparent toner, toner particles which are formed of a resin which has a high light-transmitting property and which substantially contain no colorant, and which are substantially colorless and are capable of satisfactorily permitting transmission of visible light without substantially scattering the visible light may suitably be used. However, the transparent toner can be suitably used when it becomes substantially colorless and transparent after the fixing as described above. Therefore, the transparent toner is not required to be colorless and transparent before the fixing. For example, the transparent toner may also appear white when its particles are concentrated. For example, the transparent toner can be used in such a manner that the color is separated into the four color components of CMYK and then a print pattern is determined by supplying the transparent toner at a lower print ratio portion so as to cover the entire surface of the recording material with toners and is outputted. As a result, the surface treatment can be made at any position of the medium to be treated S. In addition, the transparent toner in a certain amount may also be placed on the entire surface of the recording material. A fixing state of the toner in the electrophotographic image forming apparatus can be adjusted so that the glossiness of the printed product by the electrophotographic image forming apparatus is, e.g., about 10% in terms of 60-degree glossiness.

Further, the medium to be treated S is not limited to the recording materials formed by the above-described four-color and five-color processes but, e.g., a recording material which is subjected to the resin coating and then the image is formed thereon by the four-color process may also be used.

Further, recording materials recorded by melt-thermal transfer recording, sublimation-thermal transfer recording, ink jet recording and the like may also be similarly used as the medium to be treated S. Also in this case, by coating the recording material surface with the thermoplastic resin, the surface treatment can be effected at any develop of the entire surface of the medium to be treated S.

### 2-6. Basic Operation of Surface Treatment

First, a basic operation of the surface treatment will be described by taking as an example the case where the medium to be treated S is conveyed directly from the first conveying path 21 to the treatment unit 10, i.e., without subjecting the medium to be treated S to an overlapping operation as described later.

FIG. 9 is a schematic control diagram of the surface treatment apparatus 100 in this embodiment. The operation of the surface treatment apparatus 100 is controlled by a controller 150. To the controller 150, a treatment command (glass treatment command, gloss treatment data) is transferred from an external device 501 such as a personal computer (information terminal) or an operating portion 160 of the surface treatment apparatus 100. Then, CPU 151 as a control means provided in the controller 150 obtains the treatment command.

When a start command of the surface treatment operation is provided, sheets of the medium to be treated S are separated and fed one by one from the cassette 31, in which the sheets of the medium to be treated S as the recording material on which the image is recorded are stacked, to the inside of the apparatus main assembly 1 by the feeding roller 32. The medium to be treated S is guided into the first conveying path 21, where the medium to be treated S is nipped and conveyed by the group of the upstream conveying roller pairs 24. The medium to be treated S is conveyed to a position of the upstreammost conveying roller pair 25a of the group of the forward/reverse conveying roller pairs 25 by the flapper 27 and is stopped once for correction of the oblique movement.

Thereafter, when the group of the forward/reverse conveying roller pairs 25 are driven in a forward rotation direction and the conveyance of the medium to be treated S is resumed, the medium to be treated S is conveyed toward the treatment unit 10 in a pre-treatment conveying path 28. Thereafter, a leading end of the medium to be treated S with respect to the conveyance direction is detected by the second sensor 18 for the medium to be treated S. In synchronism with timing when the medium to be treated S passes through the second sensor 18 for the medium to be treated S, timing when the thermal head 16 is driven is controlled.

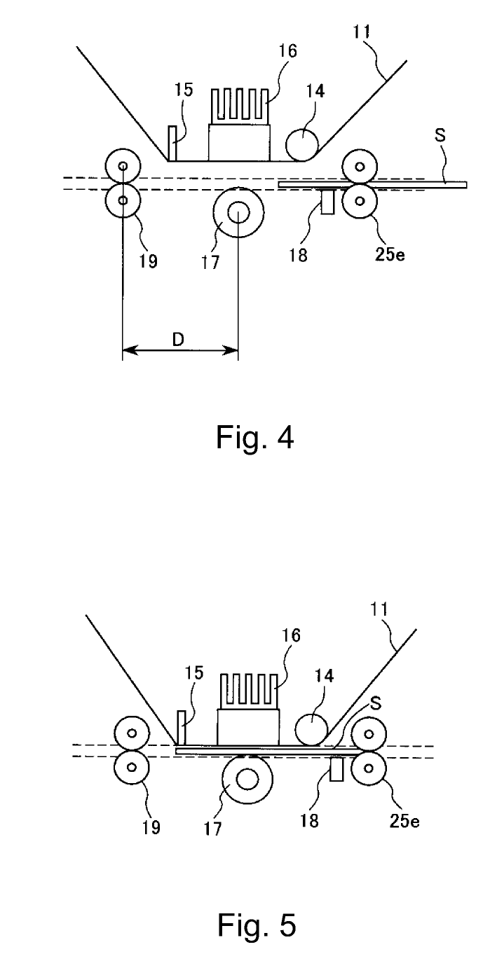

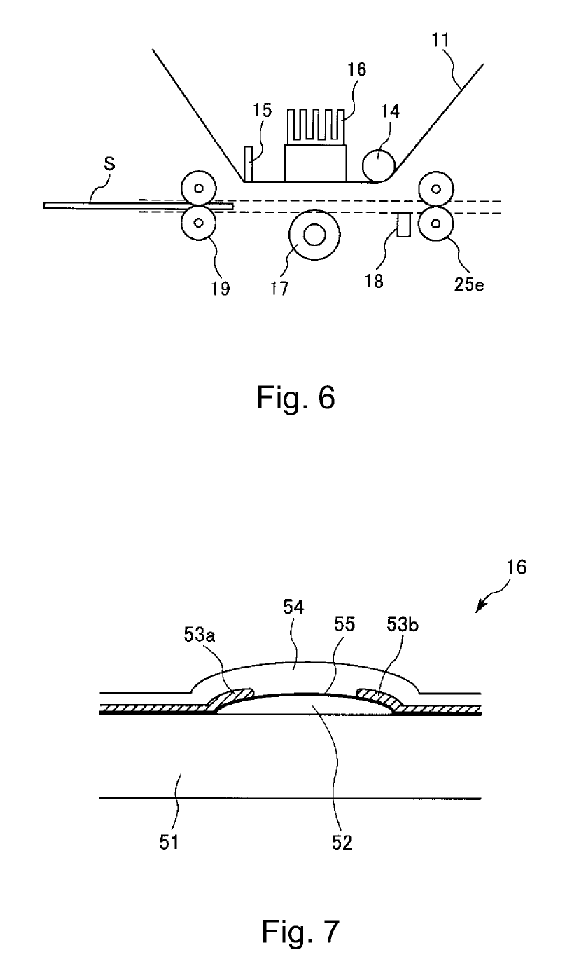

In this embodiment, as shown in FIG. 4, the thermal head 16 is stand-by in a state in which it is separated from the platen roller 17 during a normal operation. The controller 150 obtains, when the second sensor 18 detects the passing of the leading end of the medium to be treated S therethrough, timing when a treatment start position of the medium to be treated S in conveyed to the treatment portion T on the basis of the detection timing. Then, the controller 150 controls, in synchronism with the timing, drive (urging operation) of a thermal head contact and separation means so that the thermal head 16 is moved downward to be urged toward the platen roller 17 as shown in FIG. 15. In this embodiment, the thermal head contact and separation means includes an urging means such as a spring for urging a thermal head holder for supporting the thermal head 16 toward the platen roller 17. Further, the thermal head contact and separation means includes a moving means such as a cam for moving the thermal head holder in a direction, in which the thermal head holder is moved away from the platen roller 17, against an urging force of the urging means. Further, the thermal head contact and separation means includes, as a driving source, a motor for driving the moving means. The controller 150 is capable of controlling a contact and separation operation between the thermal head 16 and the platen roller 17 and its timing by controlling the driving source. The controller 150 starts the conveyance of the film 11 after the urging of the thermal head 16 is completed. That is, the winding shaft 13 is stopped in the state of FIG. 4 but is driven simultaneously when the thermal head 16 is urged toward the platen roller 17 as shown in FIG. 5.

At the treatment portion T, the platen roller 17 and the thermal head 16 for generating heat selectively depending on the treatment region image are opposed. Further, below the thermal head 16, the film 11 and the medium to be treated S below the film 11 are conveyed. The film 11 is accommodated in the film cassette C and is nipped and conveyed together with the medium to be treated S by the thermal head 16 and the platen roller 17. The controller 150 controls the heat generating resistor of the thermal head 16 so as to generate heat selectively depending on a heating pattern determined by the treatment region information described later. As a result, the toner image on the medium to be treated S is re-melted while nip-conveying the film 11 and the medium to be treated between the thermal head 16 and the platen roller 17. Downstream of the thermal head 16 with respect to the conveyance direction of the medium to be treated S, the separating member 15 is provided, so that the film 11 is separated from the medium to be treated S. In this case, the medium to be treated S is sufficiently cooled and therefore the toner image on the surface of the medium to be treated S is solidified in a state in which a surface property of the film 11 is transferred, so that desired glossiness can be provided to the medium to be treated S.

To the winding shaft 13 for the film 11 provided in the film cassette C, a driving device (winding shaft driving motor 13A) is connected. Incidentally, the driving device may also be provided to the feeding shaft 12 to prevent slack of the film 11 by winding up the film in a reverse direction. The winding shaft 13 generates tension necessary to wind up the film 11 conveyed with the conveyance of the medium to be treated S and at the same time to separate the film 11 from the medium to be treated S at the separating portion by the separating member 15. The tension necessary to separate the film 11 from the medium to be treated S is generated by setting a winding-up speed of the film at a value somewhat higher than the conveyance speed of the medium to be treated S and by interposing a torque limiter between the driving device and the winding shaft 13. Thus, the winding shaft 13 winds up, during the surface treatment, the film 11 conveyed together with the medium to be treated S while generating the tension for separating film 11 from the medium to be treated S.

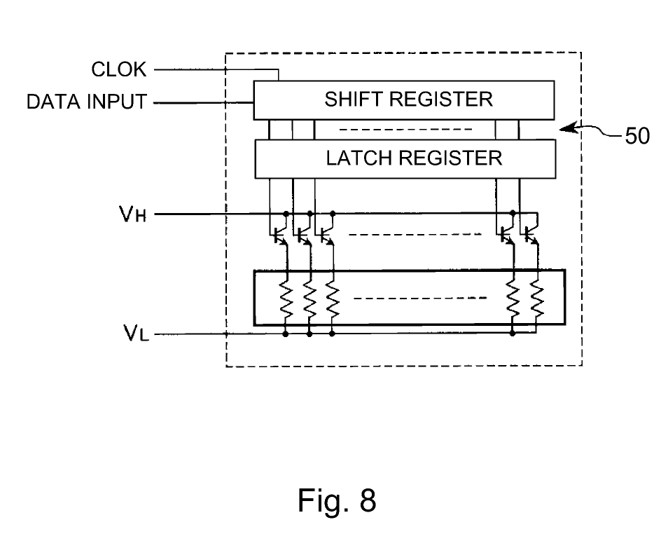

After completion of the surface treatment, the controller 150 controls the thermal head 16 so as to be separated (urging-released) from the platen roller 17 as shown in FIG. 6 and at the substantially same time so as to stop the rotation of the winding shaft 13.

Finally, the medium to be treated S is guided to the discharging roller pair 41 and then is discharged to the outside of the casing of the apparatus main assembly 1, so that the surface treatment is ended. Incidentally, the moving speed of the medium to be treated S during the surface treatment in this embodiment was controlled at 100 mm/s.

The various operations of the above-described surface treatment apparatus 100 are subjected to centralized control effected by the controller 150. The controller 150 controls the operations of the respective portions of the surface treatment apparatus 100 on the basis of a treatment command sent from a personal computer or the like or a treatment command inputted through the operating portion 160 provided on the surface treatment apparatus 100. The controller 150 includes the CPU 151 as the control means, and ROM 152 and RAM 153 as storing means, and the like. The CPU 151 executes, depending on the treatment command, the control in accordance with a program or data stored in the ROM 152 or the RAM 153. The treatment command contains the treatment region information for selectively heating the thermal head 16 in synchronism with the timing when a corresponding region passes through the treatment portion T. The thermal head 16 generates heat corresponding to a predetermined position of the medium to be treated S on the basis of the treatment region information, thus effecting the surface treatment of the medium to be treated S. The controller 150 sends, when the treatment command is sent thereto, the command to the conveying means, so that the conveyance of the medium to be treated S is started. In parallel thereto, the controller 150 also transfers the treatment region information (glossy image data, heating image data) to the thermal head driving circuit 50. After lapse of a predetermined time from the passing of the medium to be treated S through the second sensor 18 for the medium to be treated S, the controller 150 sends the command to the thermal head contact and separation means, thus urging the thermal head 16 toward the platen roller 17. The thermal head 16 effects the surface treatment (gloss treatment) at the predetermined position of the medium to be treated S on the basis of the treatment region information. Further, the controller 150 sends the command to the thermal head contact and separation means after the medium to be treated S passes through the separating portion of the separating member 15, so that the thermal head 16 is spaced from the platen roller 17.

Incidentally, in general, photograph-like high glossiness means a 60-degree glossiness (JIS Z 8741: specular glossiness-measuring method) of 40% or more, further of 80% or more. In a conventional gloss treatment method, it was difficult to partly effected the photograph-like gloss treatment in different regions of the sheets one by one. According to the surface treatment apparatus 100 in this embodiment, it is possible to partly effect the gloss treatment including not only the treatment in a photograph region such as an upper-half region of the medium to be treated S but also the treatment on the headline character or in any shape or region correspondingly to the print contents.

Here, as described above, the film 11 is conveyed together with the medium to be treated S and therefore the film 11 is conveyed in the same length as that of the medium to be treated S. As described above, in this embodiment, as the material for the film 11, the PET film which is a very thin thermoplastic film is used. This is because in order to selectively re-melt the toner on the medium to be treated S by the thermal head 16, there are needs to avoid that the electric power supplied to the thermal head 16 becomes large when the film 11 is thick and that an edge portion blurs when the heat is applied. By using such a thin film, the reduction in electric power amount and sharpness of the image can be achieved but on the other hand the film causes thermal deformation and therefore cannot be used repetitively. In this embodiment, as the medium to be treated S, the print product printed by the electrophotographic type but in general, such a print product (medium to be treated S) is provided with margins at its leading end portion and trailing end portion. In this margin portions, the toner image is not formed and therefore the surface treatment cannot be effected by the surface treatment apparatus 100 in this embodiment. Further, in the surface treatment apparatus 100, the surface treatment can be partly made but in some cases, there is no treatment region at all with respect to a sheet (paper) widthwise direction depending on the treatment region information for the surface treatment. In this embodiment, a roller pitch between the platen roller 17 and each of the downstreammost conveying roller pair 25e of the forward/reverse conveying roller pairs 25, and the downstream conveying roller pair 19 is set at about 100 mm. For this reason, when the surface treatment is effected on the medium to be treated S such as a postcard having a length of 200 mm or less, in order to convey the medium to be treated S, there is a need to urge the thermal head 16 toward the platen roller 17. In this case, at the same time, the film 11 is conveyed together with the medium to be treated S. That is, the film 11 is consumed for conveying the medium to be treated S even when there is a region which is not heated with respect to the sheet widthwise direction. Further, in the case where the sheets of the medium to be treated S are continuously passed through the treatment portion T, when the separation of the thermal head 16 from the platen roller 17 and the urging of the thermal head 16 toward the platen roller 17 are repeated between every consecutive media to be treated S (every sheet interval), the productivity is impaired in some cases. In order to improve the productivity, the surface treatment may be effected by always urging the thermal head 16 toward the platen roller 17 but in this case, the film is consumed also in the sheet interval between the medium to be treated S and a subsequent medium to be treated S.

That is, in the surface treatment method employed in this embodiment, the film is made thin down to about several microns and the thermal head as the heat source is used so as to selectively drive the heat generating resistor of the thermal head, so that the gloss property is imparted to the toner image in a desired shape at a desired position. In this method, the film is thin such that the film thickness is, e.g., about several microns and therefore the film is thermally deformed by the heating by the thermal head, so that the film cannot be repeatedly used. For that reason, the film is simple, e.g., when it is formed in a winding-up type and is used once and then thrown away. Further, in this method, at the treatment portion, the thermal head is contacted to the thin film and at the same time the flexible platen roller is disposed at an opposing portion to the thermal head via the film. Further, the surface treatment of the medium to be treated S is effected by partly heating the printed product by the thermal head while conveying the printed product at a predetermined speed. For that reason, the film is consumed simultaneously with the conveyance of the printed product. Accordingly, it is possible to partly effect the surface treatment but on the other hand, in some cases, there is a need to convey the printed product while feeding the film also at a portion in which the surface treatment is not required. Further, as a result, the amount of the consumption of the film is larger than that of the film subjected to the surface treatment, so that the running cost of the apparatus is increased in some cases. On the other hand, in order to reduce the running cost of the film, when the contact and separation operation between the thermal head and the platen roller is performed every sheet interval of every consecutive media to be treated S, the productivity can be lowered.

Therefore, one of objects of the present invention is to realize the reduction in running cost and improvement in productivity in the surface treatment apparatus 100 capable of partly controlling the surface shape (property) of the surface of the medium to be treated S by heating the medium to be treated S via the film 11 which is used once and then thrown away.

Therefore, in this embodiment, as described later specifically, in order to reduce the amount of use of the film 11, by partly superposing (overlapping) the sheets of the medium to be treated S to reduce a degree of unnecessary feeding of the film 11 generated at the sheet interval or the portion where there is no need to make the surface treatment. That is, in this embodiment, the surface treatment apparatus 100 includes the overlapping conveyance unit (overlapping portion) 20 for overlapping the plurality of sheets of the medium to be treated S with each other, so that the productivity of the surface treatment by the surface treatment apparatus 100 is improved while minimizing the amount of the consumption of the film 11.

### 3. Overlapping Conveyance Unit

The surface treatment apparatus 100 includes the overlapping conveyance unit 20 as a conveying means for the medium to be treated S (overlapping means for the medium to be treated S). The overlapping conveyance unit 20 includes the group of the upstream conveying roller pairs 24 (recording material conveying device) consisting of the plurality of conveying roller pairs 24a to 24d as the first conveying member for conveying the medium to be treated S, supplied into the apparatus main assembly 1 by the feeding roller 32, toward the treatment unit 10. The group of the upstream conveying roller pairs 24 conveys the medium to be treated S in the first conveying path 21 described later. Further, the overlapping conveyance unit 20 includes the group of the forward/reverse conveying roller pairs 25 consisting of the plurality of conveying roller pairs 25a to 25e as the second conveying member for conveying the medium to be treated S conveyed by the group of the upstream conveying roller pairs 24. The group of the forward/reverse conveying roller pairs 25 is a conveying means capable of conveying the sheets of the medium to be treated S while overlapping the sheets of the medium to be treated S and capable of conveying the medium to be treated S in the forward direction and backward direction by being rotated forward and reversely. The group of the forward/reverse conveying roller pairs 25 conveys the medium to be treated S in the pre-treatment conveying path 28. Of the group of the forward/reverse conveying roller pairs 25, the upstreammost conveying roller pair 25a also has the function of the registration roller pair for correcting oblique movement of the medium to be treated S sent from the upstream conveying roller pairs 24 and for adjusting conveyance timing of the medium to be treated S.

Further, the overlapping conveyance unit 20 includes the first sensor 26 for the medium to be treated S capable of detecting the leading end and/or the trailing end of the medium to be treated S. This first sensor 26 for the medium to be treated S is provided upstream of the upstreammost conveying roller pair 25a of the group of the forward/reverse conveying roller pairs 25 and at a position of the pre-treatment conveying path 28 located downstream of the flapper 27 with respect to the conveyance direction of the medium to be treated S. Further, the overlapping conveyance unit 20 includes the flapper 27 as a conveyance direction switching means, for switching the conveyance direction of the medium to be treated S, provided upstream of the first sensor 26 for the medium to be treated S and downstream of the group of the upstream conveying roller pairs 24 with respect to the conveyance direction of the medium to be treated S. The flapper 27 is disposed upstream of the treatment portion T with respect to the conveyance direction of the medium to be treated S and at a position with a distance from the treatment portion T larger than a maximum length of the medium to be treated S capable of being used in the surface treatment apparatus 100 with respect to the conveyance direction of the medium to be treated S.

Further, the overlapping conveyance unit 20 includes the first, second and third conveying paths 21, 22 and 23 as the plurality of conveying paths for permitting the conveyance of the sheets of the medium to be treated S, fed by the feeding roller 32 into the apparatus main assembly 1, toward the treatment unit 10 and for permitting an overlapping treatment (process) of the sheets of the medium to be treated S. The first conveying path 21 is formed by a lower conveying guide 21a and an upper conveying guide 21b. The second conveying path 22 is provided below and along the first conveying path 21 and is formed by a lower conveying guide 22a and an upper conveying guide 22b. Further, the third conveying path 23 is provided above and along the first conveying path 21 and is formed by a lower conveying guide 23a and an upper conveying guide 23b.

The flapper 27 is capable of being located at a first position for permitting passing of the medium to be treated S between the first conveying path 21 and the pre-treatment conveying path 28 and for permitting conveyance of the medium to be treated S from the first conveying path 21 to the pre-treatment conveying path 28. Further, the flapper 27 is capable of being located at a second position for permitting passing of the medium to be treated S between the second conveying path 22 and the pre-treatment conveying path 28 and for permitting conveyance of the medium to be treated S from the pre-treatment conveying path 28 to the second conveying path 22 and from the second conveying path 22 to the pre-treatment conveying path 28. In the case where the flapper 27 is located at the second position, it is impossible to convey the medium to be treated S from the pre-treatment conveying path 28 to the first conveying path 21 and from the pre-treatment conveying path 28 to the third conveying path 23. Further, the flapper 27 is capable of being located at a third position for permitting passing of the medium to be treated S between the third conveying path 23 and the pre-treatment conveying path 28 and for permitting conveyance of the medium to be treated S from the pre-treatment conveying path 28 to the third conveying path 23 and from the third conveying path 23 to the pre-treatment conveying path 28. In the case where the flapper 27 is located at the third position, it is impossible to convey the medium to be treated S from the pre-treatment conveying path 28 to the first conveying path 21 and from the pre-treatment conveying path 28 to the second conveying path 22.

The medium to be treated S fed from the cassette 31 by the feeding roller 32 is conveyed in the first conveying path 21 by the group of the upstream conveying roller pairs 24. Thereafter, the medium to be treated S is guided into the pre-treatment conveying path 28 and then is conveyed by the group of the forward/reverse conveying roller pairs 25. Further, as described later specifically, the passing of the trailing end of the medium to be treated S conveyed in the forward direction by the group of the forward/reverse conveying roller pairs 25 driven (rotated) in the forward direction is detected by the first sensor 26 for the medium to be treated S. At that time, the group of the forward/reverse conveying roller pairs 25 can be driven in the reverse direction. In this case, when the flapper 27 is located at the second position, the trailing end of the medium to be treated S is accommodated in the second conveying path 22. On the other hand, when the flapper 27 is located at the third position opposite from the second position, the trailing end of the medium to be treated S is accommodated in the third conveying path 23.

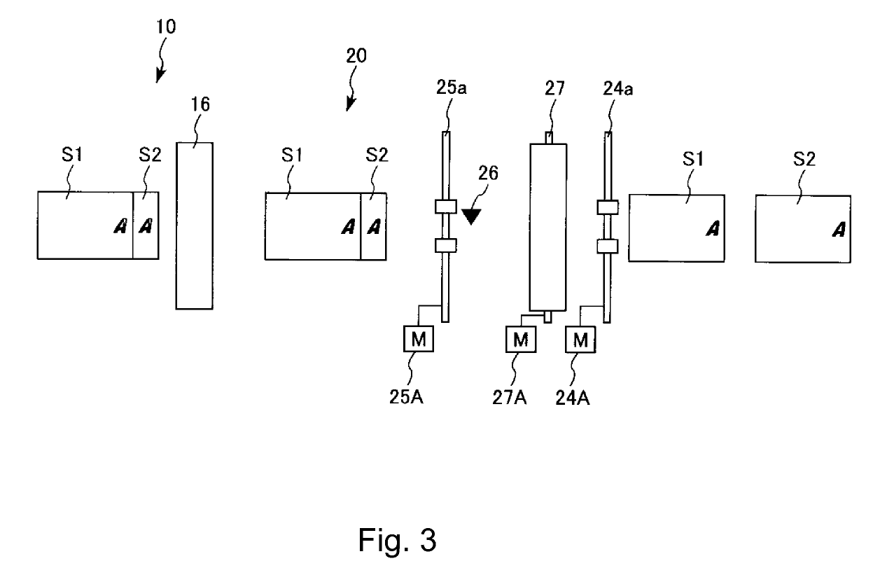

FIGS. 2 and 3 schematically illustrate a state of the conveying paths in which the sheets of the medium to be treated S are to be conveyed from the overlapping conveyance unit 20 to the treatment unit 10 as seen from above the unit. Incidentally, in FIGS. 2 and 3, only the downstreammost conveying roller pair 24a of the group of the upstream conveying roller pairs 24 and only the upstreammost conveying roller pair 25a of the group of the forward/reverse conveying roller pairs 25 are shown.

The plurality of conveying roller pairs 24a to 24d constituting the group of the upstream conveying roller pairs 24 are rotationally driven by an upstream conveying roller pair group driving motor 24A (FIGS. 2, 3 and 9) as a driving source. Further, the flapper 27 is rotationally driven by a flapper driving motor 27A (FIGS. 2, 3 and 9) as the driving source. Further, the group of the forward/reverse conveying roller pairs 25 is rotationally driven by a forward/reverse conveying roller pair group driving motor 25A (FIGS. 2, 3 and 9) as the driving source.

Incidentally, the flapper driving motor 27A and the forward/reverse conveying roller pair group driving motor 25A are capable of being rotationally driven in the forward and reverse directions.

Incidentally, in the surface treatment apparatus 100 in this embodiment, as a minimum size of the medium to be treated S, a size corresponding to a postcard size is assumed and therefore a pitch between each of adjacent rollers is about 100 mm or less. Similarly, with respect to the platen roller 17, a distance thereof from each of the upstream and downstream conveying rollers is about 100 mm.

### 4. Overlapping Method and Amount

Next, the overlapping operation of the sheets of the medium to be treated S will be described.

In this embodiment, the controller 150 calculates an overlapping amount δ from the treatment region information when the treatment command is inputted from the operating portion 160 or is received from the external device 501 via network 502. Here, the case where the continuously conveyed sheets of the medium to be treated S are subjected to continuous surface treatment in accordance with the substantially same treatment region information will be described as an example. Further, in this case, as an example, the surface treatment is effected in a region, as the treatment region, overlapping a character (e.g., “A”) formed with the toner on the medium to be treated S. Incidentally, the surface treatment is not limited to the case where it is effected in the entire region where the image is formed with the toner, but may also be effected, e.g., at a portion as a part of the character “A”.

### 4-1. Upward Overlapping (Superposition)

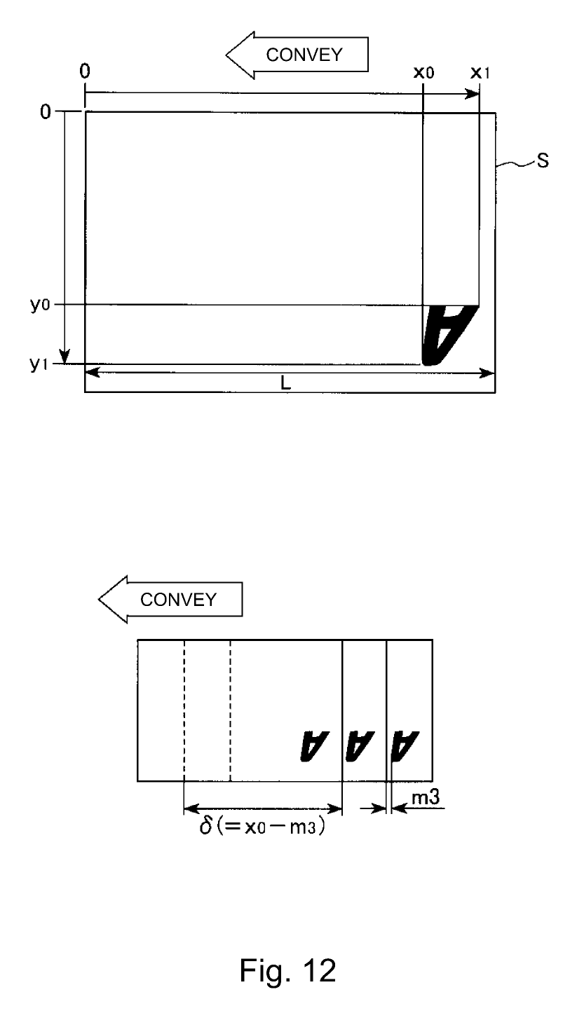

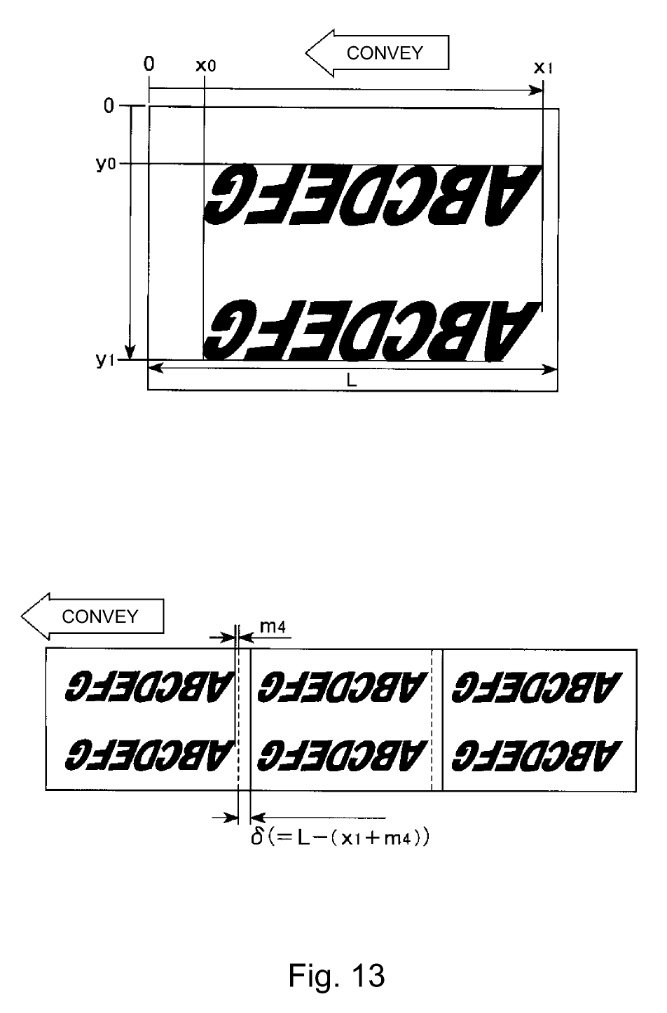

FIGS. 10 and 11 are schematic views each illustrating a relationship between the overlapping amount δ and the treatment region. In these figures, L represents a length of the medium to be treated S with respect to the conveyance direction. Further, 0 represents reference point of the medium to be treated S and in this embodiment, the upper-left corner of the leading end of the medium to be treated S in FIGS. 10 and 11 (the side opposite from the drawing sheet surface of the medium to be treated S in FIG. 1) is taken as the reference point. In FIGS. 10 and 11, x0 represents a coordinate of a downstream end point of the treatment region (glossy image, heating image) indicated by the treatment region information with respect to the conveyance direction of the medium to be treated S. Further, x1 represents a coordinate of an upstream end point of the treatment region indicated by the treatment region information with respect to the conveyance direction of the medium to be treated S.

This overlapping method is suitable for the case where x0 is smaller than the half of the length L of the medium to be treated S with respect to the conveyance direction (x0<L/s). This is because in this case, the overlapping amount δ can be made larger when a leading end portion of a subsequent medium to be treated S is superposed (laid) on a trailing end portion of the current medium to be treated S, and therefore an efficiency of use of the film 11 is improved and thus the productivity is also further improved, FIG. 2 is a schematic view of the overlapping conveyance unit 20 in the case where the upward overlapping is made.

Further, the overlapping amount δ is, from the viewpoint of stability during the surface treatment, determined by the treatment region information and the length L of the medium to be treated S with respect to the conveyance direction.

First, as shown in FIG. 10, the case where x1 is smaller than the overlapping amount δ (x1<(L+m1)/2) will be considered. Here, in the figure, m1 represents a leading end overlapping margin determined as follows. That is, the leading end overlapping margin m1 is, in the case where the sheets of the medium to be treated S are successively laid upward, a margin (distance with respect to the conveyance direction) from the coordinate x1 of the treatment region of the current medium to be treated S to the leading end of the subsequent medium to be treated S to be laid on the current medium to be treated S. In this case, the overlapping amount δ is set at a value (L−(x1+m1)) obtained by subtracting the sum of x1 and the leading end overlapping margin m1 from the length L of the medium to be treated S with respect to the conveyance direction.

On the other hand, as shown in FIG. 11, the case where x1 is larger than the overlapping amount δ (x1<(L+m2)/2) will be considered. Here, in the figure, m2 represents a trailing end overlapping margin determined as follows. That is, the trailing end overlapping margin m2 is, in the case where the sheets of the medium to be treated S are successively laid upward, a margin (distance with respect to the conveyance direction) from the trailing end of the current medium to be treated S with respect to the conveying path to the coordinate x0 of the subsequent medium to be treated S to be laid on the current medium to be treated S. In this case, the overlapping amount δ is set at a value (x0−m2) obtained by subtracting the trailing end overlapping margin m2 from x0.

That is, during the surface treatment in the treatment region, when a stepped portion of the laid sheets of the medium to be treated S enters the treatment portion (nip) T formed by the thermal head 16 and the platen roller 17, vibration is generated, so that the operation of the surface treatment becomes unstable. For that reason, by providing the above-described leading end overlapping margin m1 and trailing end overlapping margin m2, a stabilizing operation of the surface treatment portion is preferentially performed. Incidentally, these leading and trailing end overlapping margins m1 and m2 may be the same value or may also be different values as desired. Typically, these margins are the same (m1=m2=n). Further, these margins can be set appropriately depending on conveyance accuracy of the surface treatment apparatus 100, the constitution of the thermal head 16, and the like.

### 4-2. Downward Overlapping (Superposition)

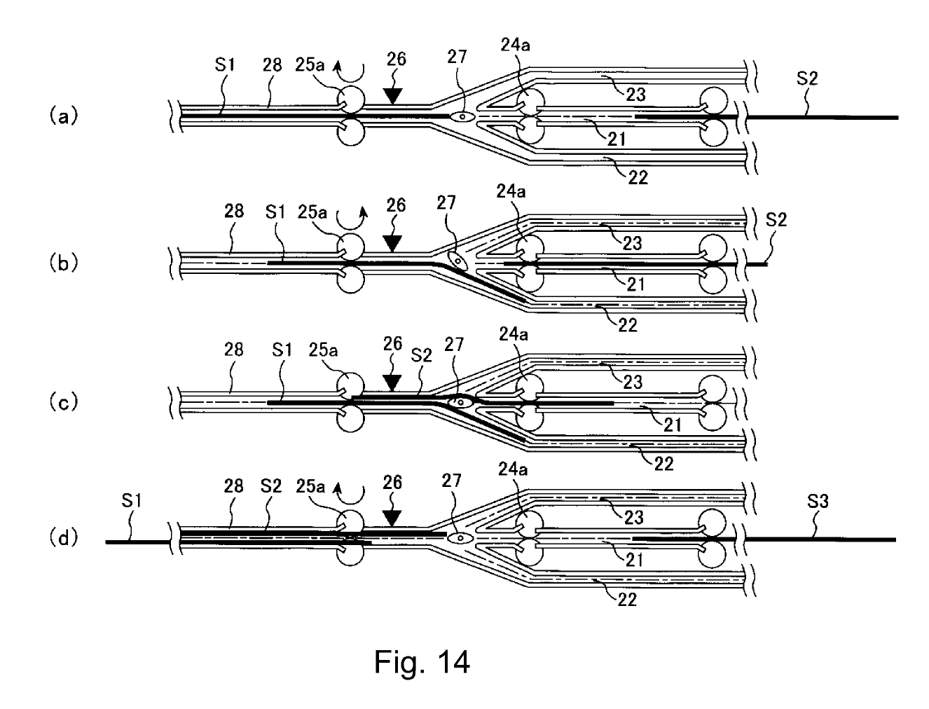

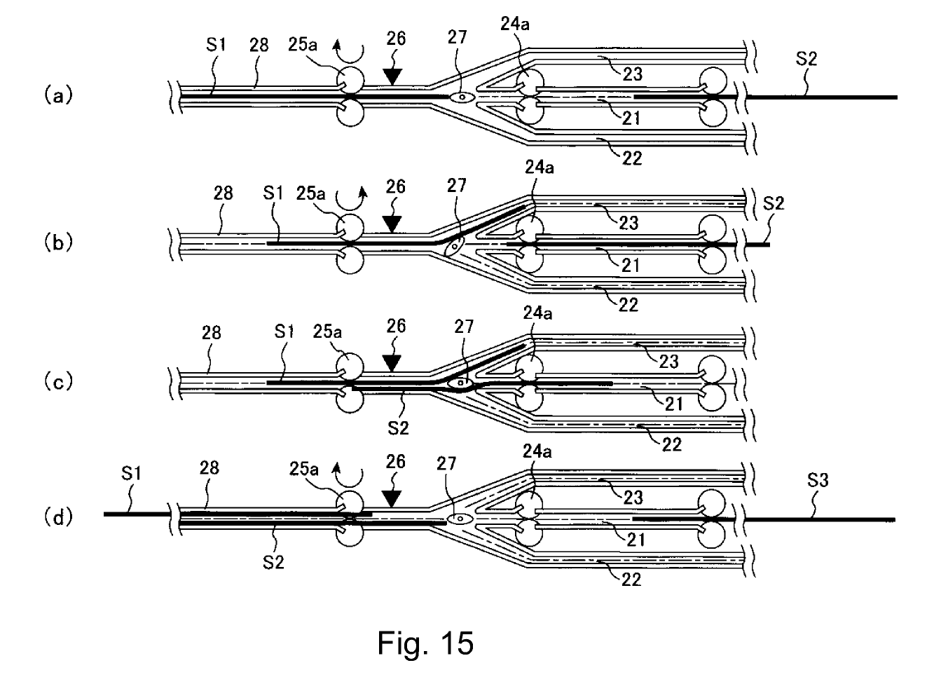

FIGS. 12 and 13 are schematic views each illustrating a relationship between the overlapping amount δ and the treatment region. In these figures, similarly as in the case of the upward overlapping L represents a length of the medium to be treated S with respect to the conveyance direction. Further, 0 represents reference point of the medium to be treated S and in this embodiment, the upper-left corner of the leading end of the medium to be treated S in FIGS. 12 and 13 (the side opposite from the drawing sheet surface of the medium to be treated S in FIG. 1) is taken as the reference point. In FIGS. 12 and 13, x0 represents a coordinate of a downstream end point of the treatment region (glossy image, heating image) indicated by the treatment region information with respect to the conveyance direction of the medium to be treated S. Further, x1 represents a coordinate of an upstream end point of the treatment region indicated by the treatment region information with respect to the conveyance direction of the medium to be treated S.

This overlapping method is suitable for the case where x0 is larger than the half of the length L of the medium to be treated S with respect to the conveyance direction (x0>L/s). This is because in this case, the overlapping amount δ can be made larger when a trailing end portion of the current medium to be treated S is superposed (laid) on a leading end portion of a subsequent medium to be treated S, and therefore an efficiency of use of the film 11 is improved and thus the productivity is also further improved, FIG. 3 is a schematic view of the overlapping conveyance unit 20 in the case where the downward overlapping is made.

Further, also in this case, the overlapping amount δ is, from the viewpoint of stability during the surface treatment, determined by the treatment region information and the length L of the medium to be treated S with respect to the conveyance direction.

First, as shown in FIG. 12, the case where (L−x1) is smaller than the overlapping amount δ (L−x1)<(L+m3)/2) will be considered. Here, in the figure, m3 represents a trailing end overlapping margin determined as follows. That is, the trailing end overlapping margin m3 is, in the case where the sheets of the medium to be treated S are successively laid downward, a margin (distance with respect to the conveyance direction) from the trailing end of the current medium to be treated S with respect to the conveying path to the coordinate x0 of the subsequent medium to be treated S to be laid under the current medium to be treated S. In this case, the overlapping amount δ is set at a value (x0−m3) obtained by subtracting the trailing end overlapping margin m3 from x0.

On the other hand, as shown in FIG. 13, the case where (L−x0) is larger than the overlapping amount δ (L−x1)<(L+m4)/2) will be considered. Here, in the figure, m4 represents a leading end overlapping margin determined as follows. That is, the leading end overlapping margin m4 is, in the case where the sheets of the medium to be treated S are successively laid upward, a margin (distance with respect to the conveyance direction) from the coordinate x1 of the treatment region of the current medium to be treated S to the leading end of the subsequent medium to be treated S to be laid under the current medium to be treated S. In this case, the overlapping amount δ is set at a value (L−(x1+m4)) obtained by subtracting the sum of x1 and the leading end overlapping margin m4 from the length L of the medium to be treated S with respect to the conveyance direction.

Similarly as in the case, during the surface treatment in the treatment region, when a stepped portion of the laid sheets of the medium to be treated S enters the treatment portion (nip) T formed by the thermal head 16 and the platen roller 17, vibration is generated, so that the operation of the surface treatment becomes unstable. For that reason, by providing the above-described trailing end overlapping margin m3 and leading end overlapping margin m4, a stabilizing operation of the surface treatment portion is preferentially performed. Incidentally, these trailing and leading end overlapping margins m3 and m4 may be the same value or may also be different values as desired. Typically, these margins are the same (m3=m4=n). Further, these margins can be set appropriately depending on conveyance accuracy of the surface treatment apparatus 100, the constitution of the thermal head 16, and the like. Further, in the cases of the upward overlapping and the downward overlapping, all of or a part of the above-described margins m1, m2, m3 and m4 can be set at the same value. Typically, all of these margins are set at the same value (m1=m2=m3=m4=m).

### 5. Overlapping Operation

Next, the overlapping operation of the medium to be treated S by the overlapping conveyance unit 20 will be described more specifically. As described above, in this embodiment, the controller 150 controls the operations of the respective portions of the overlapping conveyance unit 20, so that the following overlapping operation of the medium to be treated S is executed.

In this embodiment, the case where the sheets of the medium to be treated S are superposed by the upward overlapping method as shown in FIGS. 10 and 11 will be described as an example. The upward overlapping method is an overlapping method, of the sheets of the medium to be treated S, executed only in the case where the treatment region required to be subjected to the surface treatment is present at the leading end portion of the medium to be treated S with respect to the longitudinal direction. Further, in this embodiment, an operation for overlapping two sheets S1 and S2 of the medium to be treated S will be described specifically. Parts (a) to (d) of FIG. 14 sequentially illustrate conveying states of the two sheets S1 and S2 in the overlapping conveyance unit 20 in this case.

As shown in (a) of FIG. 14, first, in a state in which the flapper 27 is located at the first position, the first medium to be treated S1 is conveyed in the first conveying path 21 by the group of the upstream conveying roller pairs 24. Next, the medium to be treated S1 is conveyed in the pre-treatment conveying path 28 by the group of the forward/reverse conveying roller pairs 25 driven in the forward rotation direction. Then, with a predetermined sheet interval, the second medium to be treated S2 is conveyed in the first conveying path 21 by the group of the upstream conveying roller pairs 24.

As shown in (b) of FIG. 14, thereafter, the leading end of the first medium to be treated S1 is detected by the first sensor 26 for the medium to be treated S. Then, from the detection result, at the time when location of the trailing end of the first medium to be treated S1 at a position downstream of the flapper 27 is detected, the position of the flapper 27 is switched to the second position. Further, at that time, the group of the forward/reverse conveying roller pairs 25 is driven in the reverse rotation direction, so that the trailing end of the first medium to be treated S1 is guided and accommodated in the second conveying path 22 by the flapper 27. At the time when a distance from the group of the forward/reverse conveying roller pairs 25 (the upstreammost conveying roller pair 25a) to the leading end of the first medium to be treated S1 is equal to an exposure distance (L−δ) (e.g., x1+m1 in FIG. 10), the drive of the group of the forward/reverse conveying roller pairs 25 in the reverse rotation direction is stopped.

As shown in (c) of FIG. 14, thereafter, the position of the flapper 27 is switched to the first position. Then, the second medium to be treated S2 is conveyed in the first conveying path 21 by the group of the upstream conveying roller pairs 24 and the leading end thereof passes through the flapper 27 and then is conveyed to the group of the forward/reverse conveying roller pairs 25. Then, after a lapse of a predetermined time from detection of the leading end of the second medium to be treated S2 by the first sensor 26 for the medium to be treated S<the leading end of the second medium to be treated S2 reaches the group of the forward/reverse conveying roller pairs 25 (the upstreammost conveying roller pair 25a). At the same time, the drive of the group of the forward/reverse conveying roller pairs 25 in the forward direction is started, so that the first medium to be treated S1 and the second medium to be treated S2 are conveyed in a superposed (overlapped) state ((d) of FIG. 14).

Also after the second medium to be treated S2, in the case where feeding of the sheets of the medium to be treated S is continued in the order of the third medium to be treated S3, the fourth medium to be treated S4, and the later sheets, the above-described operation is repeated. As a result, with respect to the third medium to be treated S3 and the later sheets, it becomes possible to successively convey the sheets in the superposed state with the predetermined overlapping amount δ.

Incidentally, (a) to (d) of FIG. 15 sequentially illustrate the conveyance states of the media to be treated S1 and S2 by the overlapping unit 20 in the case where the sheets of the medium to be treated S are superposed by the downward overlapping method as shown in FIGS. 12 and 13. The downward overlapping method is an overlapping method of the medium to be treated S executed in the case where the treatment region necessary to effect the surface treatment is present only at the trailing end portion of the medium to be treated S with respect to the conveyance direction. In this case, in the state of (b) of FIG. 15 corresponding to the state of FIG. 14, the position of the flapper 27 is switched to the third position. As a result, the trailing end of the first medium to be treated S1 is guided and accommodated in the third conveying path 23. Other operations of the drive and the like of the flapper 27 and the conveying roller pairs 24 and 25 are performed in accordance with the case of the upward overlapping method shown in (a) to (d) of FIG. 14 and therefore will be omitted from redundant description.

Incidentally, in this embodiment, the overlapping amount δ is required to be more than the conveyance distance from the group of the forward/reverse conveying roller pairs 25 (the upstreammost conveying roller pair 25a) to the flapper 27.

### 6. Flow of Overlapping Operation and Surface Treatment

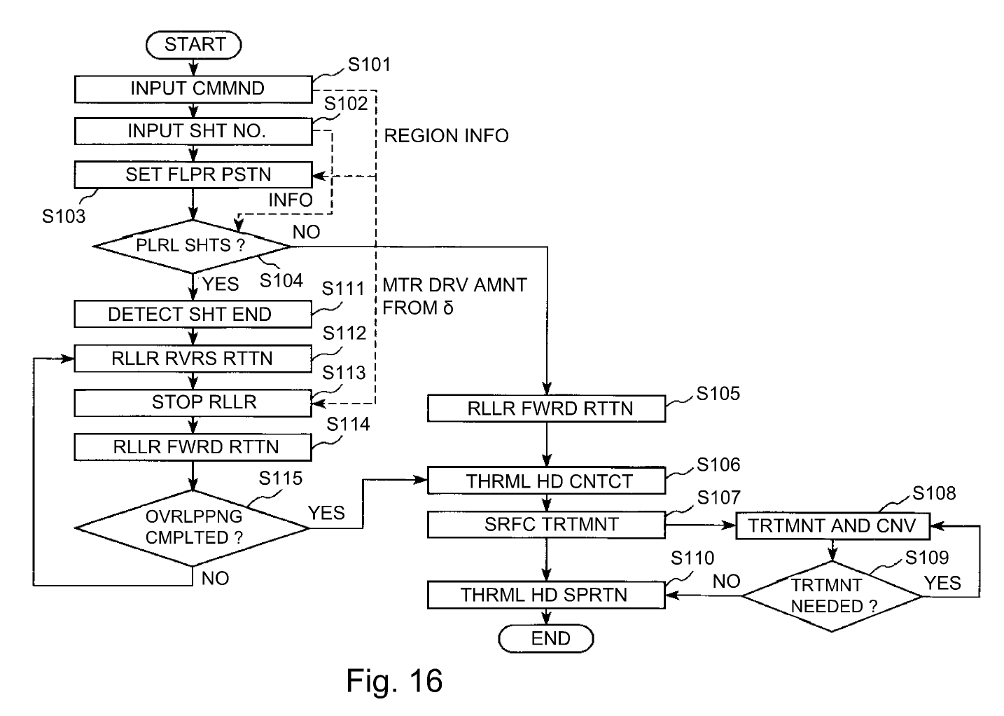

Next, along a flow chart of FIG. 16, flow the overlapping operation and the surface treatment will be described. As described above, in this embodiment, the controller 150 controls the overlapping operation by the overlapping conveyance unit 20 and the surface treatment operation by the treatment unit 10, so that the overlapping operation and the surface treatment operation are executed in the following manner.

In this embodiment, the case where the sheets of the medium to be treated S are superposed by the upward overlapping method as shown in FIGS. 10 and 11 will be described as an example. The upward overlapping method is the overlapping method of the medium to be treated S executed in the case where there is a need to effect the surface treatment only at the leading end portion of the medium to be treated S with respect to the conveyance direction.

The treatment region information and print number information are inputted from the operating portion 160 of the surface treatment apparatus 100 or the external device 150 into the controller 150 via the network 502 or the like (S101, S102). Then, the controller 150 selects the overlapping method on the basis of the treatment region information and the print number information. Further, depending on the selected overlapping method, in the above-described manner, the overlapping amount δ (drive timing of the group of the forward/reverse conveying roller pairs 25) and the switching direction and timing of the position of the flapper 27 are set (S103).

Then, in the case where the print number indicated by the inputted print number information is one (sheet) (NO of S104), a calculated overlapping amount δ0 is 0 and therefore the controller 150 always drives the group of the forward/reverse conveying roller pairs 25 in the forward rotation direction (S105). Then, the medium to be treated S conveyed by the group of the forward/reverse conveying roller pairs 25 passes through the treatment portion (nip) T formed by the thermal head 16 and the platen roller 17, so that the surface treatment is effected (S106, S107).

Thereafter, when the leading end of the medium to be treated S reaches the downstream conveying roller pair 19, the medium to be treated S is conveyed by the treatment portion (nip) T and the downstream conveying roller pair 19 (S108). At this time, in the case where the surface treatment has already been not required, the nip between the thermal head 16 and the platen roller 17 at the treatment portion T is released to stop the feeding of the film 11 (NO of S109, S110). The case where the surface treatment has already been not required is specifically the following case. That is, the case is such that the exposure amount (L−δ) (e.g., x1+m1 in FIG. 10) of the leading end portion of the medium to be treated S in the case where the surface treatment is effected is smaller than a distance D (between the centers of rollers) from the downward conveying roller pair 19 to the treatment portion T, i.e., the case of D>(L−δ), e.g., D>(x1+m1) in FIG. 10.

On the other hand, in S104, in the case where the print number indicated by the inputted print number information is plural sheets (“YES”), the controller 150 switches the position of the flapper 27 in accordance with the above-described overlapping operation with reference to (a) to (d) of FIG. 14. Then, by repeating the operations of the forward rotation, the reverse rotation and stop of the rotation of the group of the forward/reverse conveying roller pairs 25, a designated print number of sheets of the medium to be treated S are superposed while keeping the predetermined overlapping amount δ (S111 to S115).

Thereafter, the predetermined number of sheets of the medium to be treated S are laid and conveyed by the group of the forward/reverse conveying roller pairs 25 and then are passed through the treatment portion (nip) T formed by the thermal head 16 and the platen roller 17, so that the surface treatment is made (S106, S107).

Thereafter, the same operations as those in the case where the inputted print number is one (sheet) are performed (S108 to S110). Incidentally, in the case where the surface treatment of the plurality of superposed sheets of the medium to be treated S is effected, when the surface treatment has already been not required at the time when the leading end of the final medium to be treated S reaches the downstream conveying roller pair 19, the following operation is performed. That is, similar as in the above-described case of the single medium to be treated S, the nip between the thermal head 16 and the platen roller 17 at the treatment portion T is released, so that the feeding of the film 11 is stopped. Further, in the case where the surface treatment of the plurality of superposed sheets of the medium to be treated S is effected, in consideration of the overlapping amount δ, the surface treatment is effected in a predetermined treatment region on each of the sheets of the medium to be treated S.

As described above, the sheets of the medium to be treated S are conveyed as a set of superposed sheets after being superposed at a predetermined position correspondingly to a portion necessary to be surface-treated on the medium to be treated S. As a result, an amount of use of the film 11 can be reduced. For example, in accordance with this embodiment, 10 sheets of postcard (148 mm×100 mm) are continuously fed, conveyed and surface-treated at a conveyance speed of 100 mm/s under a condition of 100 mm in sheet interval and 80 mm in overlapping amount (20 mm in amount of use of the film 11 per sheet). In this case, a total amount of consumption of the film 11 is 200 mm. In the case where the surface treatment is effected without performing the overlapping operation in this embodiment, the total amount of consumption of the film 11 is 2252 mm. Thus, according to this embodiment, the consumption amount of the film 11 can be reduced by 91.1%. Further, during the surface treatment of the sheets of the medium to be treated S continuously conveyed in the overlapped state, the nip formed by the thermal head 16 and the platen roller 17 is not released, so that the productivity of the surface treatment is also improved.

As described above, according to this embodiment, the surface treatment apparatus 100 includes the film 11 to be conveyed while contacting the surface of the medium to be treated S and the film conveying means 13 for conveying the film 11. Further, the surface treatment apparatus 100 as the heating apparatus includes the heating means 16 for selectively heating different surface regions of the medium to be treated S via the film 11 with respect to the direction substantially perpendicular to the conveyance direction of the medium to be treated S in contact with the surface of the film 11 opposite from the film surface contacting the medium to be treated S. Further, the surface treatment apparatus 100 includes the following conveying means 20 for the medium to be treated S. That is, the conveying means 20 conveys the plurality of sheets of the medium to be treated S to the contact portion T to the film 11 while overlapping at least a part of the plurality of sheets of the medium to be treated S. In this case, the conveying means 20 overlaps at least the part of the plurality of sheets of the medium to be treated S in a state in which the treatment region, of the plurality of sheets of the medium to be treated S, to be selectively heated by the heating means 16 via the film 11 is exposed to the film 11.

Particularly, in this embodiment, the conveying means 20 has the first conveying path 21 for receiving the fed medium to be treated S. Further, the conveying means 20 has the first conveying member 24 for conveying the medium to be treated S in the first conveying path 21 in the forward direction in which the medium to be treated S is conveyed toward the contact portion T to the film 11. Further, the conveying means 20 has the second conveying member 25 disposed downstream of the first conveying member 24 with respect to the forward direction. The second conveying member 25 is capable of not only conveying in the forward direction the medium to be treated S conveyed by the first conveying member 24 but also conveying the medium to be treated S in the opposite (backward) direction. Further, the conveying means 20 has the second conveying path 22, different from the first conveying path 21, for receiving the medium to be treated S conveyed in the opposite direction by the second conveying member 25. Further, the conveying means 20 has the switching means 27 for switching the conveyance direction of the medium to be treated S conveyed in the opposite direction by the second conveying member 25 to a direction toward the second conveying path 22. Further, the surface treatment apparatus 100 as the heating apparatus conveys the first medium to be treated S1, conveyed in the forward direction by the second conveying member 25, in the opposite direction toward the second conveying path 21. Thereafter, in a state in which the second conveying member 25 is stopped, the second medium to be treated S2 fed into the first conveying path 21 subsequently to the first medium to be treated S1 is conveyed in the forward direction to the second conveying member 25 by the first conveying member 24. Thereafter, by the second conveying member 25, the first and second media to be treated S1 and S2 are conveyed in the forward direction in the overlapping state. Further, in this embodiment, the surface treatment apparatus 100 includes the control means 151 for controlling, depending on the treatment region of each of the plurality of sheets of the medium to be treated S, whether the plurality of sheets of the medium to be treated S are conveyance overlapped upward or downward by the conveying means 20 for the medium to be treated S.

As described above, according to this embodiment, in the surface treatment apparatus 100 capable of partly controllable the surface shape (property) of the surface of the medium to be treated S by heating the medium to be treated S via the film 11 which is used once and then thrown away, it is possible to realize the reduction in running cost and the improvement in productivity.

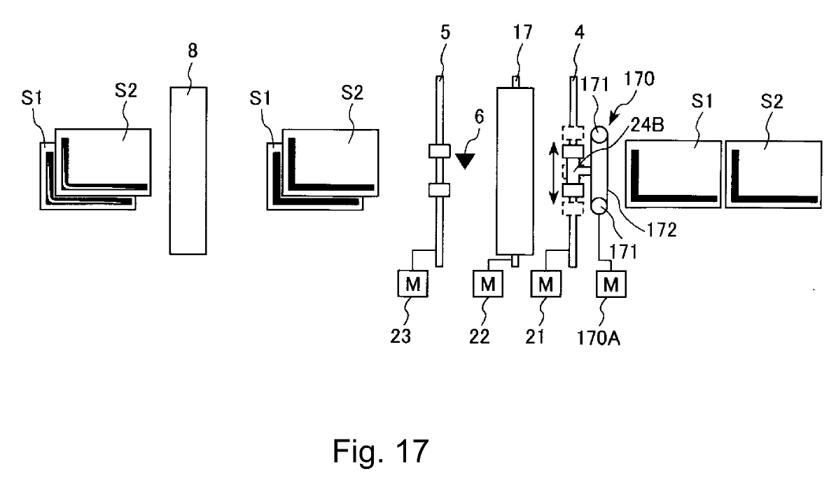

Incidentally, in this embodiment, the case where the plurality of sheets of the medium to be treated S are overlapped with the overlapping amount of each sheet of the medium to be treated S set at a predetermined value with respect to only the conveyance direction of the medium to be treated S was described. As desired, it is also possible to overlap, with respect to the direction substantially perpendicular to the conveyance direction of the medium to be treated S, the plurality of sheets of the medium to be treated S with the overlapping amount set at the predetermined value. For example, as shown in FIG. 17, the upstream conveying roller pairs 24 provided upstream of the flapper 27 is constituted so as to be slidably movable in the direction substantially perpendicular to the conveyance direction of the medium to be treated S. More specifically, a moving means 170 for slidably moving a supporting member 24 for supporting the upstream conveying roller pairs 24 in both directions along its rotational axis (directions substantially perpendicular to the conveyance direction of the medium to be treated) is provided. The moving means 170, e.g., connects the supporting member 24B to a belt 172 stretched between pulleys 171 which are capable of being rotated forward and reversely, and then the pulleys 171 are driven by a moving means driving motor 170A as the driving source controlled by the controller 150. In this case, the sheets of the medium to be treated S can be overlapped with the overlapping amount of each sheet set at the predetermined value is not only the conveyance direction of the medium to be treated S but also the direction substantially perpendicular to the conveyance direction. By sliding the medium to be treated S before the overlapping operation, the flow of other overlapping operation and surface treatment can be made the same as those with respect to the above-described conveyance direction. Thus, the upstream conveying roller pairs 24 can be constituted so as to be slidably movable. That is, the conveying means 20 further includes the moving means 170, provided upstream of the switching means 27 with respect to the forward direction, capable of moving the medium to be treated S in the direction substantially perpendicular to the conveyance direction of the medium to be treated S. As a result, as shown in FIG. 17, in the case where the treatment region is located at one end portion of the medium to be treated S with respect to the direction substantially perpendicular to the conveyance direction of the medium to be treated S, the sheets of the medium to be treated S are overlapped also with respect to the direction substantially perpendicular to the conveyance direction of the medium to be treated S<so that it becomes possible to further reduce the consumption amount of the film 11.

### Embodiment 2

In this embodiment, elements (portions) having the substantially same constitutions as those for the heating apparatus (surface treatment apparatus) in Embodiment 1 are represented by the same reference numerals or symbols and will be omitted from the detailed description.

In Embodiment 1, the surface treatment apparatus 100 as the heating apparatus was an independent apparatus for effecting the surface treatment of the recording material, as the medium to be treated, on which the image was separated formed by the electrophotographic image forming apparatus. However, the heating apparatus (surface treatment apparatus) may also be connected to the electrophotographic image forming apparatus, and the recording material on which the image is formed by the image forming apparatus may be constituted, as the medium to be treated, into the surface treatment apparatus.

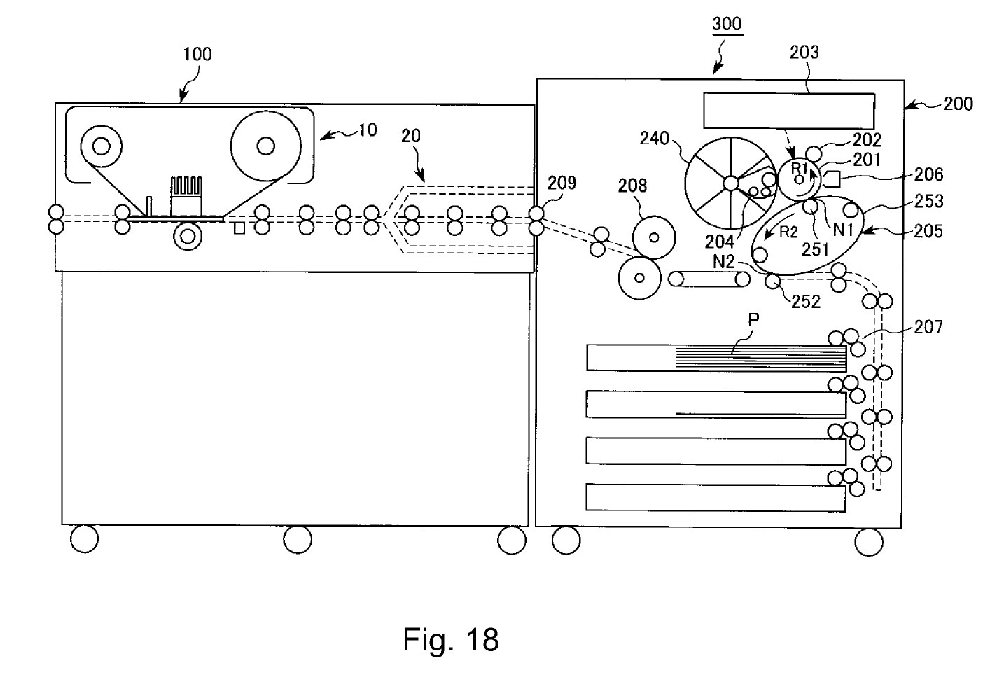

FIG. 18 is a schematic sectional view showing a general structure of an image forming system provided with a surface treatment apparatus according to an embodiment of the present invention. In this embodiment, a surface treatment apparatus 100 and an electrophotographic image forming apparatus 200 are connected to constitute an image forming system 300. In the image forming system 300, the image is formed with a thermally meltable toner on the recording material P such as a recording sheet by the electrophotographic process in the image forming apparatus 200 and then the recording material P is delivered to the surface treatment apparatus 100 connected in the downstream side of the image forming apparatus 200 with respect to the conveyance direction of the recording material P. The surface treatment apparatus 100 effects treatment (surface treatment) for controlling the surface shape (property) of the surface of the recording material P, as the medium to be treated S, on which the image is formed, and then outputs the recording material P.

In this embodiment, the image forming apparatus 200 is a one-drum type image forming apparatus, of an intermediary transfer type, capable of forming a full-color image by using the electrophotographic process.

The image forming apparatus 200 includes a photosensitive drum 201 which is a drum-type electrophotographic photosensitive member as an image bearing member. The photosensitive drum 201 is rotationally driven in an arrow R1 direction in FIG. 18. Around the photosensitive drum 201, the following means are provided in the named order along a rotational direction of the photosensitive drum 1. First, a charging roller 202 as a charging means is provided. Next, an exposure device (laser scanner) 203 as an exposure means is provided. Next, a rotary developing device 240 provided with a plurality of developing devices 204 as a developing means is provided. Next, an intermediary transfer unit 205 as a transfer means is provided. Next, a drum cleaner 206 as a photosensitive member cleaning means is provided.

The intermediary transfer unit 205 includes an endless belt-like intermediary transfer belt 253 as an intermediary transfer member. The intermediary transfer belt 253 is stretched by a plurality of stretching rollers and is rotationally driven in an arrow R2 direction in FIG. 18. On an inner peripheral surface of the intermediary transfer belt 253, a primary transfer roller 251 as a primary transfer means is provided at a position where it opposes the photosensitive drum 201 to form a primary transfer portion (primary transfer nip) N1 where the intermediary transfer belt 253 and the photosensitive drum 201 contact each other. Further, on an outer peripheral surface of the intermediary transfer belt 253, a secondary transfer roller 252 as a secondary transfer means is provided so as to form a secondary transfer portion (secondary transfer nip) N2 in contact with the intermediary transfer belt 253.

In this embodiment, the rotary developing device 203 includes the developing device 204 using a clear (transparent) toner in addition to the developing devices using the color toners of C (cyan), M (magenta), Y (yellow) and K (black). The surface treatment apparatus 100 is the apparatus for imparting the gloss property by re-heating the toner image to transfer the surface property of the film 11 and therefore it is difficult to sufficiently impart the gloss property at an image portion where the toner amount is relatively small. For this reason, by using the clear toner at the image portion, where the toner amount is relatively small, and at a margin portion and the like, it becomes possible to effect gloss treatment also at such portions. Incidentally, the clear toner is used and therefore does not adversely affect the original full-color image.

Incidentally, each of the four color toners of YMCK is fine powder principally containing a resin and a pigment, and the clear toner is fine powder which does not contain the pigment and principally contains the resin. In this embodiment, as the resin for the clear toner, polyester resin was used.

The image forming apparatus 200 is constituted by further including a feeding portion 207 for feeding the recording material P, a fixing portion 208 for fixing the toner image on the recording material P, a discharging portion 209 for conveying the recording material P from the image forming apparatus 200 to the surface treatment apparatus 100, and the like.

The image forming apparatus 200 having such a constitution is capable of forming the full-color image containing the clear toner by the same operation as that of an ordinary electrophotographic image forming apparatus. As an example, the case where the full-color image containing the clear toner is formed will be described. During the image formation, the surface of the rotating photosensitive drum 201 is uniformly charged by the charging roller 202. Further, the charged surface of the photosensitive drum 201 is subjected to scanning exposure depending on an image signal of a separated component color by the exposure device 203 into which the image signal is inputted. As a result, an electrostatic latent image (electrostatic image) depending on the image signal is formed on the photosensitive drum 201. The electrostatic latent image formed on the photosensitive drum 201 is developed into a toner image by supplying the toner of an associated color thereto by the developing device 204 corresponding to the separated component color. The toner image formed on the photosensitive drum 201 is primary-transferred onto the intermediary transfer belt 253 by the action of the primary transfer roller 251. Such steps of the charging, the exposure, the development and the primary transfer are repeated plural times corresponding to the number of necessary separated component colors (YMCK and clear in this embodiment), so that a multi-color toner image of color toner images which are successively primary-transferred superposedly onto the intermediary transfer belt 253 is formed. The toner images formed on the intermediary transfer belt 253 are secondary-transferred collectively onto the recording material P by the action of the secondary transfer roller 252. The recording material P is conveyed from the feeding portion 207 to the secondary transfer portion N2 in synchronism with the multi-color toner image on the intermediary transfer roller 253. Further, with this timing, the secondary transfer roller 252 is contacted to the intermediary transfer belt 253. The recording material P on which the toner image is transferred is conveyed to the fixing device 18 in which the toner image is fixed on the recording material P under application of heat and pressure. The toner remaining on the photosensitive drum 201 after the primary transfer step is removed and collected by the drum cleaner 206. Further, the toner remaining on the intermediary transfer roller 253 after the secondary transfer step is removed and collected by an unshown cleaning means. Then, the recording material P on which the image is fixed is conveyed, as the medium to be treated S to be surface-treated in the surface treatment apparatus 100, to the surface treatment apparatus 100 by the discharging portion 209.

The surface treatment apparatus 100 is connected to the discharging portion 209 of the image forming apparatus 200. For that reason, a discharge tray provided at the discharging portion of the ordinary image forming apparatus 200 and the feeding devices (the cassette 31 and the feeding roller 32 and the like) provided at the feeding portion of the surface treatment apparatus 100 are not incorporated into the image forming system 300 in this embodiment.

Further, the constitution of the surface treatment apparatus is the substantially same as that in Embodiment 1. However, in this embodiment, as described above, the cassette 31 and the feeding roller 32 in the surface treatment apparatus 100 in Embodiment 1 are not provided, and the recording material P on which the image is formed is directly conveyed, as the medium to be treated S, from the image forming apparatus 100 into the surface treatment apparatus 100. Further, in this embodiment, the controller 150 can control the operations of the respective portions of the surface treatment apparatus 100 on the basis of a treatment command inputted from the image forming apparatus 200 or a treatment command inputted through the operating portion 160 provided on the surface treatment apparatus 100. The treatment command contains the treatment region information for selectively heating the thermal head 16 in synchronism with the timing when a corresponding region passes through the treatment portion T. The thermal head 16 generates heat corresponding to a predetermined position of the medium to be treated S on the basis of the treatment region information, thus effecting the surface treatment of the medium to be treated S. Similarly as in Embodiment 1, the controller 150 may also be constituted so that a treatment command from the external device 501 such as a personal computer is inputted into the controller 150.

The recording material P (medium to be treated S), to be discharged from the discharging portion 209 of the image forming apparatus 200, on which, e.g., the full-color image containing the clear toner is formed is conveyed to the group of the upstream conveying roller pairs 24 (recording material conveying device) of the surface treatment apparatus 100. The gloss treatment of the medium to be treated S conveyed to the group of the upstream conveying roller pairs 24 is effected similarly as that described in Embodiment 1.

In the case where the gloss treatment is effected in such an in-line manner, treatment capacity of the surface treatment apparatus 100 may desirably be higher than print processing capacity of the image forming apparatus 200. In the case where the treatment capacity of the surface treatment apparatus 100 is lower than the print processing capacity of the image forming apparatus 200, the print processing capacity of the surface treatment apparatus 100 is required to coincide with the treatment capacity by lowering the print speed of the image forming apparatus 200 or increasing the sheet interval.

Thus, by connecting the surface treatment apparatus 100 to the discharging portion 209 of the image forming apparatus 200, it become possible to effect the in-line gloss treatment, so that the productivity when the print subjected to the gloss treatment is prepared is improved. Further, it is also possible to connect a post-treatment device such as a binding apparatus or a sorting device to the surface treatment apparatus 100 at a position downstream of the surface treatment apparatus 100.

Even when such an image forming system 300 is used in combination with each of the image forming apparatuses 100 described in Embodiment 1 and 2, the same effects as those in Embodiments 1 and 2 can be achieved.

### Other Embodiments

In the above-described embodiments, as the case where the surface shape (property) of the surface of the medium to be treated is controlled, the case where the glossy image is formed on the once-outputted image was described. On the other hand, the toner is required to represent a metallic color such as gold or silver in some cases. In the electrophotographic image forming apparatus in which the image is formed by using an electrostatic force, it is difficult in principle to use a metallic material as the toner which is a base material for forming the image. In a thermal transfer printer (thermal transfer type) using a thermal head, as a metallic ink, e.g., a metal deposition layer is formed on a film and then is thermally transferred, so that the metallic image can be formed (JP-A 2001-130150). The film used in the thermal transfer type includes a film base material and an ink layer coated on the film base material. The ink layer can be coated on the film base material via a parting layer and on which an adhesive layer can be provided. In the case where not only gold and silver but also such a metallic color is formed on the image on the print by the post-treatment, it is important to efficiently use the film to realize the reduction in running cost and the improvement of the productivity. The present invention is also applicable to a surface treatment apparatus in which the film on which the ink of the metallic color such as gold or silver is used as the above-described film and is heated by the thermal head and thus the metallic color image is thermally transferred onto the once-outputted image. The surface treatment of the medium to be treated also includes the case where the metallic color ink is thermally transferred partly onto the surface of the medium to be treated to represent a metallic property such as metallic gloss. That is, the film may have a surface layer different in surface roughness from the thermally plastic resin image surface of the medium to be treated or a coating of the ink to be transferred onto the surface of the medium to be treated by being melted under heating. Thus, the present invention is applicable to the surface treatment apparatus for partly controlling the surface shape (property) of the surface of the medium to be treated by heating the medium to be treated via the film or for thermally transfer partly the thermally meltable ink on the film onto the surface of the medium to be treated by heating the medium to be treated via the film.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 136284/2011 filed Jun. 20, 2011, which is hereby incorporated by reference.

What is claimed is:

1. A heating apparatus comprising:
a film contactable to a recording material;
a film conveying device for conveying said film;
a heating device, contactable to a surface of said film opposite from another surface of said film where said film is contactable to the recording material, for selectively heating the recording material via said film with respect to a direction substantially perpendicular to a conveyance direction of the recording material;
a recording material conveying device for conveying the recording material toward a contact portion where the recording material is to be contacted to said film; and
a control device for controlling, when a plurality of recording materials are heated by said heating device, said recording material conveying device to convey the recording materials toward the contact portion so that a heating region of the recording material to be selectively heated by said heating device is contacted to said film and so that at least a part of a region of the recording material other than the heating region overlaps another recording material.

2. An apparatus according to claim 1, wherein said control device controls said recording material conveying device as to whether the plurality of recording materials are successively laid upward or downward on the basis of image form on the heating region of each of the plurality of recording materials.

3. An apparatus according to claim 1, wherein said recording material conveying device is capable of moving the recording material in the direction substantially perpendicular to the recording material conveyance direction.
